(19) United States
(12) Patent Application Publication
(10) Pub. No.: US 2010/0208894 A1
(43) Pub. Date: Aug. 19, 2010

(54) ENCODER AND DECODER APPARATUS AND METHODS

(75) Inventors: Paul LeeRoy True, Merlin, OR (US); Justin Garrett Hopper, Grants Pass, OR (US); Chris Reed Murphy, Grants Pass, OR (US); Ammon Joseph Gomez, Grants Pass, OR (US); Adam Stubblefield, Incline Villiage, NV (US)

Correspondence Address: Silicon Forest Patent Group;Paul J. Fordenbacher, 11876 NW Tyler Ct, Portland, OR, 97229, US

(73) Assignee: LINX TECHNOLOGIES, INC., Merlin, OR (US)

(21) Appl. No.: 12/443,472

(22) PCT Filed: Sep. 28, 2007
(86) PCT No.: PCT/US2007/080007

§ 371 Date: Mar. 27, 2009

Related U.S. Application Data
(60) Provisional application No. 60/827,653, filed on Sep. 29, 2006.
(60) Provisional application No. 60/829,144, filed on Oct. 11, 2006.

(51) Int. Cl. H04K 1/00; H04L 9/06

(52) U.S. Cl. 380/270; 380/277; 380/255

(57) ABSTRACT

Embodiments provide remote control encoders and decoders, encryption algorithms and methods, singularly and in combination, and not limited thereto.

### RELATED APPLICATIONS

This is a PCT patent application claiming benefit to U.S. provisional patent application No. 60/827,653, filed on Sep. 29, 2006, which is in its entirety incorporated herewith by reference, and U.S. provisional patent application No. 60/829,144, filed on Oct. 11, 2006, which is in its entirety incorporated herewith by reference.

### FIELD

This invention relates to security systems. More particularly, the invention relates to integrated circuit devices suitable for use in remote control devices, and to remote control devices comprising the integrated circuit devices and to a security system.

### BACKGROUND

Wireless remote control devices based on radio frequency (RF) or infrared (IR) communication are growing in popularity and finding their way into more applications. Remote keyless entry (RKE) systems are known in the art for operating locks and accessories on cars, operating garage doors, and activating building alarms. The idea behind wireless remote control is simple: a button press or contact closure on a transmitter product causes some action to be taken at a receiver product.

FIG. 1 is a schematic view of an embodiment of a wireless control system 100. The wireless control system 100 comprises a transmitter product 102 and a receiver product 104. The transmitter product 102 comprises a transmitter switch unit 106, an encoder 108, and a transmitter 110. The transmitter switch unit 106 comprises one or more transmitter switches 112, such as, but not limited to, electro-mechanical contacts suitable for providing an open or closed electrical state to the encoder 108 communicated via an encoder data line 114. When one of the one or more encoder data lines 114 on the encoder 108 is activated by a transmitter switch 112, the encoder 108 generates a data packet intended for transmission. The packet can be transmitted by any means of serial data transfer, such as, but not limited to, a radio frequency (RF) or infrared (IR) link. The encoder 108 communicates the data packet to the transmitter 110 via an encoder output line 116. The transmitter 110 is suitable to affect the wireless transmission of the data packet.

FIG. 1 also shows a schematic view of a receiver product 104. The receiver product 104 comprises a receiver 118 and a decoder 120. The receiver 118 is suitable for wireless communication with the transmitter 110, including the reception of the data packet. The data packet is communicated from the receiver 118 to the decoder 120 via a decoder input line 122. The decoder 120 has one or more decoder data output lines 124 that are suitable for communication with the electrical circuitry that is to be controlled 126.

Encoders, which are found in the transmitter product, record the status of inputs, usually button or contact closures, as binary data and combine it with an identifier, forming an encoded data packet. The encoded data packet is communicated via a transmitted signal. Upon successful reception of the encoded data packet by the decoder, the decoder output lines are set to replicate the states of the encoder data lines. These decoder output lines can be used to control the application circuitry.

FIG. 2 is an example of a data packet generated by an encoder. An address 202 is combined with bits representing the states of the encoder input lines 204 and a preamble 200 to create a data packet 206. In first generation encoders, the address 202 is usually set manually with one or more DIP switches; that is, a series of tiny switches housed in a dual in-line package as a component of a circuit board. The DIP switches on both the encoder and decoder are set to the same state or combination of on/off positions by the user. These DIP switch-based encoders/decoders are relatively easy to use, but have significant security vulnerabilities. Since the encoder uses the same address 202 in every transmission based on the state of the DIP switches, the address 202 is subject to code grabbing. This is where an attacker records the transmission from an authorized transmitter product and replays the transmission to gain access to the receiver. Since the same address 202 is used with every transmission, the decoder in the receiver product does not have the capability to verify that the transmission was sent by an authorized transmitter product rather than a clone or a recording.

Further, the number of unique addresses 202 that are provided by the various combinations of switch positions on the DIP-switch type of encoder/decoder is relatively small, determined by the number of switches provided (2ⁿ possible addresses, where n is the number of switches, so 10 switches gives 2¹⁰ or 1024 addresses). Increasing the number of switches will increase the number of unique addresses 202 and increase security, but it becomes unmanageable for the user and too expensive to implement the hardware. Unauthorized communication with the receiver product can, therefore, also be obtained by way of an exhaustive search in which all the different switch combinations of a particular transmitter product are tested to see which one is readable by the decoder in the receiver product.

Second generation encoders utilize a changing code to guard against code grabbing. Rather than using a hardware key in the form of DIP switches, these systems use logic keys representative of far more switches than could be practically provided by a hardware DIP switch. Also, a counter value is added to the data packet that is used to compare with a complementary counter data in the decoder as a further validity check.

FIG. 3 is an example of a data packet generated by second generation encoders and decoders. Counter data 306 is combined with bits representing the states of the encoder data lines 304. These are encrypted to hide their value. The resulting encrypted portion 310 is added to a serial number 302. This serial number 302 creates the fixed portion of the packet 308. A preamble 300 is added to distinguish the packet from random noise.

There remains the problem that since the encoder and decoder utilize the same key, which is one of a finite combination of possibilities, the attacker could either try using random numbers or go through all possible combinations sequentially to try to get the key. Also, in some cases, each transmitter/receiver product manufacturer is assigned a limited number of keys by the encoder/decoder manufacture and/or cryptographic licensor that are used in their particular products. The unique key is set or stored in both the encoder and decoder at the transmitter/receiver product production line to create encoder/decoder product matched pairs. The equipment manufacturer would commonly connect the encoder to a special programmer during production that programs either a key or a seed value that is used to generate a key into its memory. The decoder is commonly also programmed with a seed value during production. The user would place the decoder into a special Learn Mode during which it would be able to calculate a particular encoder's key. This process is inefficient for a number of reasons. The equipment manufacturer must purchase special, expensive programmers for the parts and must include a step in production to program them. Also, a list of seed values is stored at the manufacturer's location. These values are usually saved so that replacement units can be manufactured. This offers a potential security risk to those using the parts since the key can be compromised and adds cost to the manufacturing process, in part due to the programming steps, which is passed on to the consumer. Also, only a finite number of keys are provided to each transmitter/receiver product manufacturer, which reduces the uniqueness from one system to another from the same transmitter/receiver product manufacturer. Also, the security of the keys provided to one transmitter/receiver product manufacturer may be compromised by a disgruntled employee or other security breach, putting the entire production of transmitter/receiver products using such compromised keys at risk.

Older generation encoder/decoder products are commonly implemented in hardware as state machines. A state machine is a circuit that is comprised of discrete logic gates and components that perform a specific function. They are usually created in silicon and packaged as an integrated circuit. They do not require programming and are inexpensive to manufacture, but if a change is required, the circuit must be redesigned and a new batch of ICs must be manufactured. This process makes the initial design of a product very expensive.

New technology and processes have made a microcontroller implementation of these products more economical. A microcontroller is a computer on a chip that is designed to run a single program that is stored in memory within the chip. Since the instructions for the product are stored as a program, if a mistake is found or a change is needed, the microcontrollers can simply be updated with new software rather than scrapped. Since microcontrollers can be programmed for many different functions, they can be used in a wide variety of applications. This allows a microcontroller manufacturer to aggregate many customers together and realize a greater economy of scale than would be possible with a dedicated state machine. This economy of scale brings the cost of a microcontroller close to that of a state machine, but the development time and costs are significantly reduced.

What is needed in the art is a wireless remote control system that provides a high level of security with the ease-of-use and flexibility of fixed-address systems. The manufacturer and end user alike should be able to easily set-up the system without any special or proprietary equipment while maintaining a high level of secrecy for the key.

### SUMMARY

In accordance with an embodiment, a method of encryption and decryption for an encoder and decoder wireless transmission system is provided, comprising reading a latest counter value from memory, checking the logic state of encoder input lines and assembling these states into a command byte, generating an n-bit data block comprising the command byte, the counter value, and an authentication value, encrypting the n-bit data block using a block cipher forming an encrypted data block, transmitting the encrypted data block to the decoder as a packet, adjusting the counter value, overwriting the counter value in the memory, and encrypting the n-bit data block upon each packet transmission, receiving a packet by the decoder, decrypting the packet using the block cipher, and setting decoder output lines to the state corresponding to the command byte.

In another embodiment, the method further comprises wherein encrypting the n-bit data block comprises dividing the n-bit data block into two m-bit half-blocks referred respectively as plaintext A and plaintext B and encrypting plaintext A and plaintext B.

In another embodiment, the method further comprises wherein generating an n-bit data block comprises generating a 128-bit data block and wherein dividing the data block into two m-bit half-blocks comprises dividing the data block into two 64-bit half-blocks.

In another embodiment, the method further comprises wherein encrypting plaintext A and plaintext B comprises encrypting plaintext A and plaintext B using a block cipher in an encryption mode.

In another embodiment, the method further comprises wherein using a block cipher in an encryption mode comprises using a block cipher in an encryption mode selected from the list consisting of CMC, EME, ECB and CBC.

In another embodiment, the method further comprises wherein the n-bit data block is a 128-bit data block and encrypting plaintext A and plaintext B comprises encrypting plaintext A and plaintext B using a 64-bit block cipher resulting in two 64-bit half-blocks referred respectively as ciphertext A and ciphertext B, mixing ciphertext A and ciphertext B using a mixing algorithm, resulting in two 64-bit half-blocks referred respectively as ciphertext A′ and ciphertext B′, and encrypting ciphertext A′ and ciphertext B′ using the 64-bit block cipher resulting in two 64-bit half-blocks referred respectively as ciphertext A″ and ciphertext B″

In another embodiment, the method further comprises wherein encrypting the n-bit data block comprises encrypting the n-bit data block using a cipher known as the Skipjack cipher.

In another embodiment, the method further comprises wherein encrypting plaintext A and plaintext B comprises encrypting plaintext A and plaintext B using a cipher known as the Skipjack cipher, and wherein encrypting ciphertext A′ and ciphertext B′ comprises encrypting ciphertext A′ and ciphertext B′ using the Skipjack cipher.

In another embodiment, the method further comprises adding a preamble and a user identification to the encrypted data block prior to transmitting the encrypted data block to the decoder as a packet.

In another embodiment, the method further comprises adding a preamble and the user identification to ciphertext A″ and ciphertext B″ to create packet A and packet B, respectively, in combination referred to as a message.

In another embodiment, the method further comprises wherein encrypting the n-bit data block comprises encrypting the n-bit data block using a cipher known as the AES cipher.

In another embodiment, the method further comprises checking the hamming weight of ciphertext A″ and ciphertext B″ and logically inverting the half-block if its duty cycle is greater than a threshold.

In another embodiment, the method further comprises wherein checking the hamming weight of ciphertext A″ and ciphertext B″ and logically inverting one or both of ciphertext A″ and ciphertext B″ if its duty cycle is greater than a threshold comprises checking the hamming weight of ciphertext A″ and ciphertext B″ and logically inverting one or both of ciphertext A″ and ciphertext B″ if its duty cycle is greater than 50%.

In another embodiment, the method further comprises calculating the hamming weight, defined as the number of ‘1’s in a string of bits, of each of ciphertext A″ and ciphertext B″ to determine the duty cycle before transmission of the respective packet, the duty cycle defined as the ratio of ‘1’s to ‘2’s in the data, and logically inverting all of the bits in either or both of ciphertext A″ and ciphertext B″ if the respective duty cycle is greater than a threshold.

In another embodiment, the method further comprises wherein decrypting the packet comprises decrypting the message including packet A and packet B, comprising, receiving the message, checking the preamble of packet A ensuring that it matches a pre-determined pattern, removing the preamble and user identification from packet A if the preamble is valid, checking for inversion due to hamming weight, recovering ciphertext A″ from packet A, checking the preamble of packet B ensuring that it matches a pre-determined pattern, removing the preamble and user identification from packet B if the preamble is valid, checking for inversion due to hamming weight, recovering ciphertext B″ from packet B, using the received user identification to find a counter value and a key in decoder non-volatile memory, using the key and the decryption algorithm to decrypt ciphertext A″ and ciphertext B″ to recover the plaintext A and plaintext B, respectively, and testing plaintext A and plaintext B for authenticity by comparing the authentication pattern and counter against expected values stored in non-volatile memory.

In another embodiment, the method further comprises wherein using the key and the decryption algorithm to decrypt ciphertext A″ and ciphertext B″ to recover the plaintext A and plaintext B, respectively, comprises, using the key and a decryption algorithm corresponding to the encryption algorithm to decrypt the ciphertext A″ block to recover the ciphertext A′ block, using the key and the decryption algorithm corresponding to the encryption algorithm to decrypt the ciphertext B″ block to recover the ciphertext B′ block, processing ciphertext A′ and ciphertext B′ with the inverse of the mixing algorithm so as to recover ciphertext A and ciphertext B, and using the key and the decryption algorithm to decrypt ciphertext A and ciphertext B to recover the plaintext A and plaintext B, respectively.

In another embodiment, the method further comprises performing the logical AND function on the command byte and control permissions stored in the decoder non-volatile memory to obtain an output byte if the plaintext A and plaintext B are validated, the AND function comparing bits in both bytes and outputting a logic 1 only if the bit is high in both bytes.

In another embodiment, the method further comprises activating a line on the decoder if the encoder instructs the decoder to take a line high and it is allowed by the control permissions.

In another embodiment, the method further comprises wherein generating an n-bit data block comprising the command byte, the counter value, and an authentication pattern comprises generating a 128-bit data block comprising the command byte, the counter value, and an 80-bit authentication pattern.

In another embodiment, the method further comprises wherein generating an n-bit data block comprising the command byte, the counter value, and an authentication pattern comprises generating a 128-bit data block comprising an 8-bit command byte, a 40-bit counter value, and an 80-bit authentication pattern.

In another embodiment, the method further comprises activating decoder output lines only for as long as valid messages are received instructing the decoder to activate them, and deactivating the decoder output lines once the transmission of messages has stopped and the decoder times out.

In another embodiment, the method further comprises activating decoder output lines upon reception of a valid transmission, holding the output lines high until the valid transmission is received a second time, and deactivating the output lines upon receipt of the second valid transmission.

In another embodiment, the method further comprises wherein the decoder toggles the state of the decoder output lines when there is a break in the messages and the decoder times out.

In another embodiment, the method further comprises updating latched values in the output byte on the first loop through the receive and decrypt routine.

In another embodiment, the method further comprises wherein updating the latched values comprises, checking which bits are active in the output byte, checking the logic state of the associated output lines, setting the active bits in the output byte to the logical inverse of the state of the associated lines, and setting the output lines to the logic states set in the output byte using a logical XOR function.

In another embodiment, the method further comprises having all of the decoder output lines either latched or momentary based on the state of a single decoder input line, making all of the output lines latched if the decoder input line is high, and making all of the output lines momentary if the decoder input line is low.

In another embodiment, the method further comprises having all of the decoder output lines either latched or momentary based on the state of the respective decoder input line, making the respective output lines latched if the corresponding decoder input line is high, and making the respective output lines momentary if the corresponding decoder input line is low.

In another embodiment, the method further comprises updating the state of the decoder output lines, wherein updating the state of the decoder output lines comprises, checking the mode of the individual decoder output lines, setting the state of the output line according to the command in the output byte if the line is momentary, and setting the state of the output line in accordance with the result of XORing the output line with the appropriate bit in the command byte if the line is latched, the state of the decoder output line is XORed with the appropriate bit in the command byte and the decoder output line is set according to the result.

In another embodiment, the method further comprises wherein if Latch Mode is active and if it is the first run through the loop, the activated lines in the output byte are inverted from their current state and the output lines are set according to the output byte and wherein if Latch Mode is not active, the decoder output lines are set according to the output byte.

In another embodiment, the method further comprises wherein if this is the first run through the loop, the method further comprising, outputting the user identification on a decoder output line, setting a timer and looking for more messages on a decoder input line, repeating if more messages are present, writing the current counter value to memory and exiting the algorithm if the timer runs out before more messages are received.

In an embodiment, a system for an encoder and decoder wireless transmission system is provided comprising an encoder and decoder, the encoder comprising, checker means adapted to check the logic state of encoder input lines and assembling these states into a command byte, storage means adapted to store the command byte, an authentication value, and a counter value, combiner means adapted for combining the command byte, the authentication value, and counter value into an n-bit data block, encryption means adapted to encrypt the n-bit data block forming an encrypted data block, transmitter means adapted to transmit the encrypted data block as a packet to the decoder, decrementer means adapted for decrementing the counter and encrypting the data block upon each packet transmission, the decoder comprising, storage means adapted to store a key and the counter value, receiver means adapted to receive the encrypted data block as a packet from the encoder, reader means adapted to read the key and the counter value, and decryption means adapted to decrypt the data block using the key and the block cipher to recover the command byte, setter means adapted to set the decoder output lines to the state corresponding to the command byte.

In another embodiment, the system further comprises wherein the combiner means adapted to combine the command byte, authentication value, and counter value into a data block and the encryption means adapted to encrypt the data block comprises, combiner means adapted for combining the command byte, the authentication value, and counter value into an n-bit data block, divider means adapted for dividing the n-bit data block into two m-bit half-blocks plaintext A and plaintext B, respectively, encryption means adapted for encrypting each of the plaintext A and plaintext B generating ciphertext A″ and ciphertext B″, adder means adapted for adding a user identification value and a preamble value to each of the ciphertext A″ and ciphertext B″ generating packet A and packet B, respectively, transmitter means adapted to transmit packet A and packet B as a message to the decoder, and wherein the receiver means adapted for receiving the packet from the encoder, reader means adapted for reading the key and the counter value, and decryption means adapted for decrypting the encoder data block using the key and recovering the command byte comprises, receiver means adapted for receiving the message including packet A and packet B from the encoder, remover means adapted for removing the preamble and identification value from each of packet A and packet B recovering ciphertext A″ and ciphertext B″, respectively, reader means adapted for reading the key and the counter value, and decryption means adapted for decrypting ciphertext A″ and ciphertext B″ using the key and the block cipher recovering plaintext A and plaintext B, respectively.

In another embodiment, the system further comprises wherein the encryption means adapted for encrypting the plaintext A and plaintext B generating ciphertext A″ and ciphertext B″ comprises, encryption means adapted for encrypting each of the plaintext A and plaintext B generating ciphertext A and ciphertext B, respectively, mixer means adapted for mixing ciphertext A and ciphertext B and means for dividing into ciphertext A′ and ciphertext B′, encryption means adapted for encrypting each of the ciphertext A′ and ciphertext B′ generating ciphertext A″ and ciphertext B″, adder means adapted for adding a user identification value and a preamble value to each of the ciphertext A″ and ciphertext B″ generating packet A and packet B, respectively, and wherein decryption means adapted for decrypting ciphertext A″ and ciphertext B″ using the key and recovering plaintext A and plaintext B, respectively, comprises, decryption means adapted for decrypting ciphertext A″ and ciphertext B″ using the key and the block cipher recovering ciphertext A′ and ciphertext B′, respectively, unmixer means adapted for unmixing ciphertext A′ and ciphertext B′ recovering ciphertext A and ciphertext B, respectively, and decryption means adapted for decrypting ciphertext A and ciphertext B using the block cipher recovering plaintext A and plaintext B, respectively.

In another embodiment, the system further comprises a decoder input line in electrical communication with the decoder, voltage means adapted for supplying a voltage, a switch in electrical communication between the decoder input line and the voltage means adapted for supplying a voltage, the switch adapted to supply voltage to the decoder input line upon the closing of the switch, a timer in electrical communication with the decoder input line, the timer adapted to sense the state of the input line and output a multi-bit timer value upon sensing a voltage or not sensing a voltage; wherein storage means adapted for storing a key in the decoder comprises decoder non-volatile memory in communication with the timer, the decoder non-volatile memory adapted to store one or more bits of each multi-bit timer value and combine them with any previously stored bits of multi-bit timer values, defining a key.

In another embodiment, the system further comprises wherein storage means adapted for storing a key in the encoder comprises encoder non-volatile memory, the encoder further comprising encoder communication means for communicating with the decoder non-volatile memory, the decoder further comprising decoder communication means adapted for communicating with the encoder non-volatile memory, the decoder adapted to communicate the contents of the decoder non-volatile memory to the encoder non-volatile memory via the encoder communication means adapted for communicating with the decoder non-volatile memory and the decoder communication means adapted for communicating with the encoder non-volatile memory.

In another embodiment, the system further comprises wherein the encoder communicator means adapted for communicating with the decoder non-volatile memory and the decoder communicator means for communicating with the encoder non-volatile memory comprises electrical contacts for temporary coupling therebetween.

In another embodiment, the system further comprises wherein the encoder communicator means for communicating with the decoder non-volatile memory includes an infrared transmitter and the decoder communicator means for communicating with the encoder non-volatile memory includes an infrared receiver.

In an embodiment, a wireless transmission system is provided comprising a transmitter product and a receiver product, the transmitter product comprising, a transmitter switch unit, an encoder, and a transmitter, the transmitter switch unit comprises one or more transmitter switches suitable for providing an open or closed electrical state to the encoder communicated via an encoder data line, the encoder comprises an encoder input line suitable for communication with a decoder output line on the decoder, the encoder further comprises a counter and an encryption means adapted for encrypting a data block using a counter value and an encryption algorithm into an encrypted data block as a packet, the transmitter adapted to transmit the packet to the receiver product, the encoder adapted to communicate the packet to the transmitter, the transmitter adapted to affect a wireless transmission of the packet, the encoder adapted to decrement the counter and encrypt the data block upon each packet transmission, the receiver product comprises a receiver and a decoder, the receiver is adapted to receive the data packet via wireless communication with the transmitter, the receiver being in electrical communication with the decoder via a decoder input line, the decoder further comprises a decryption means for decrypting the encoded data block in the packet using an encryption algorithm, the decoder includes one or more decoder output lines adapted for communication with electrical circuitry, the decoder further includes decoder output lines for communicating with the encoder, the decoder includes one or more decoder input lines adapted for electrical communication with decoder switches, the decoder comprising means for creating a key.

In another embodiment, the system further comprises wherein the encryption means for encrypting comprises encryption means for encrypting using an encryption algorithm operated in a mode of operation.

In another embodiment, the system further comprises wherein the mode of operation selected from the list consisting of CMC, EME, ECB and CBC.

In another embodiment, the system further comprises wherein the means for encrypting the n-bit data block forming an encrypted data block comprises, divider means for dividing the n-bit data block into two m-bit half-blocks plaintext A and plaintext B, respectively, encryption means for encrypting each of the plaintext A and plaintext B generating ciphertext A and ciphertext B, respectively, mixer means for mixing ciphertext A and ciphertext B and divider means for dividing into ciphertext A′ and ciphertext B′, encryption means for encrypting each of the ciphertext A′ and ciphertext B′ generating ciphertext A″ and ciphertext B″, adder means for adding a user identification value and a preamble value to each of the ciphertext A″ and ciphertext B″ generating packet A and packet B, respectively, and wherein decryption means for decrypting ciphertext A″ and ciphertext B″ and recovering plaintext A and plaintext B, respectively, comprises, decryption means for decrypting ciphertext A″ and ciphertext B″ recovering ciphertext A′ and ciphertext B′, respectively, unmixer means for unmixing ciphertext A′ and ciphertext B′ recovering ciphertext A and ciphertext B, respectively, and decryption means for decrypting ciphertext A and ciphertext B recovering plaintext A and plaintext B, respectively.

In another embodiment, the system further comprises the decoder further comprising, an input line, voltage means for supplying a voltage, a switch in electrical communication between the input line and the voltage means, the switch adapted to supply voltage to the input line upon the closing of the switch, and a timer in electrical communication with the input line, the timer adapted to sense the state of the input line and output a multi-bit timer value upon sensing a voltage or not sensing a voltage, wherein storage means for storing a key in the decoder comprises decoder non-volatile memory in communication with the timer, the decoder non-volatile memory adapted to store one or more bits of each multi-bit timer value and combine them with any previously stored bits of multi-bit timer values defining a key.

In another embodiment, the system further comprises wherein storage means for storing a key in the encoder comprises encoder non-volatile memory, the encoder further comprising encoder communicator means for communicating with the decoder non-volatile memory, the decoder further comprising decoder communicator means for communicating with the encoder non-volatile memory, the decoder adapted to communicate the contents of the decoder non-volatile memory to the encoder non-volatile memory via the decoder communicator means for communicating with the decoder non-volatile memory and the encoder communicator means for communicating with the encoder non-volatile memory.

In another embodiment, the system further comprises wherein the decoder communicator means for communicating with the decoder non-volatile memory and the encoder communicator means for communicating with the encoder non-volatile memory comprises electrical contacts for temporary coupling therebetween.

In another embodiment, the system further comprises wherein the decoder communicator means for communicating with the decoder non-volatile memory includes an infrared transmitter and the encoder communicator means for communicating with the encoder non-volatile memory includes an infrared receiver.

In an embodiment, a method of generating an encryption key in a decoder of a wireless remote control system is provided, comprising activating and deactivating an input line on the decoder between high and low voltage one or more times, triggering a timer upon each rise and fall of voltage on the input line, upon each trigger the timer outputting a multi-bit timer value, recording the timer values, and combining the timer values defining the key.

In another embodiment, the method further comprises wherein recording the timer values comprises recording a plurality of low-order bits of each of the timer values.

In another embodiment, the method further comprises wherein activating and deactivating an input line between high and low voltage one or more times comprises activating and deactivating an input line between supply voltage and ground voltage ten times, wherein triggering a timer upon each rise and fall of voltage on the input line, upon each trigger the timer outputting a multi-bit timer value comprises triggering a timer each time the input line goes from low to high voltage and from high to low voltage, upon each trigger the timer outputting a multi-bit timer value having at least four bits, wherein recording the timer values comprises storing the four least significant bits of each timer value into non-volatile memory within the decoder, and wherein combining the timer values defining the key comprises generating an 80-bit key by combining the four least significant bits of twenty timer values.

In another embodiment, the method further comprises wherein activating and deactivating an input line comprises pressing and releasing a switch in electrical communication between the input line and a voltage source.

In another embodiment, the method further comprises wherein triggering a timer upon each rise and fall of voltage on the input line, upon each trigger the timer outputting a multi-bit timer value comprises triggering an 8-bit timer upon each rise and fall of voltage on the input line, upon each trigger the timer outputting an 8-bit timer value, wherein recording the timer value bits comprises recording the last two bits of each of the 8-bit timer values, and wherein combining the timer values comprises combining the last two bits of each of the 8-bit timer values.

In an embodiment, a method of generating an encryption key in a decoder is provided, comprising, activating and deactivating an input line of the decoder between high and low voltage one or more times, triggering a timer upon each rise of voltage of the input line, upon each trigger the timer outputting a multi-bit timer value, recording the timer values, and combining the timer values defining the key.

In another embodiment, the method further comprises triggering a timer upon each fall of voltage on the input line, upon each trigger the timer outputting a multi-bit timer value.

In another embodiment, the method further comprises wherein recording the timer value comprises recording a plurality of low-order bits of the timer value.

In another embodiment, the method further comprises wherein activating and deactivating an input line between high and low voltage one or more times comprises activating and deactivating an input line between supply voltage and ground voltage ten times, wherein triggering a timer upon each rise and fall of voltage on the input line, upon each trigger the timer outputting a multi-bit timer value comprises triggering a timer each time the input line goes from low to high voltage and from high to low voltage, upon each trigger the timer outputting a multi-bit timer value having at least four bits, wherein recording the timer values comprises storing the four least significant bits of each timer value into non-volatile memory within the decoder, and wherein combining the timer values defining the key comprises combining the four least significant bits of twenty timer values defining an 80-bit key.

In another embodiment, the method further comprises wherein activating and deactivating an input line comprises pressing and releasing a switch in electrical communication between the input line and a voltage source.

In another embodiment, the method further comprises wherein triggering a timer upon each rise and fall of voltage on the input line, upon each trigger the timer outputting a multi-bit timer value comprises, triggering an 8-bit timer upon each rise and fall of voltage on the input line, upon each trigger the timer outputting an 8-bit timer value, wherein recording the timer value bits comprises recording the last two bits of each of the 8-bit timer values, and wherein combining the timer values comprises combining the last two bits of each of the 8-bit timer values.

In an embodiment, a method of generating an encryption key in a decoder of a wireless remote control system is provided, comprising, incrementing a high-speed counter by activating an input line high voltage and continuing until deactivating an input line by taking the input line low voltage, determining a multi-bit counter value and recording one or more of the lowest-order bits of the counter value, and adding the one or more of the lowest-order bits of the counter value to the key, incrementing the counter until the input line is taken high voltage and recording one or more of the lowest-order bits of the counter value and adding the one or more of the lowest-order bits of the counter value to the key, and repeating until the key has been filled.

In another embodiment, the method further comprises wherein determining a multi-bit counter value and recording one or more of the lowest-order bits of the counter value, and adding the one or more of the lowest-order bits of the counter value to the key comprises determining a multi-bit counter value of at least four bits and recording the four lowest-order bits of the counter value, and adding the four lowest-order bits of the counter value to the key, and wherein incrementing the counter until the input line is taken high voltage and recording one or more of the lowest-order bits of the counter value and adding the one or more of the lowest-order bits of the counter value to the key comprises incrementing the counter until the input line is taken high voltage and recording the four lowest-order bits of the counter value and adding the four low-order bits of the counter value to the key.

In another embodiment, the method further comprises wherein activating and deactivating an input line between high and low voltage one or more times comprises activating and deactivating an input line between supply voltage and ground voltage ten times, wherein triggering a timer upon each rise and fall of voltage on the input line, upon each trigger the timer outputting a multi-bit timer value comprises triggering a timer each time the input line goes from low to high voltage and from high to low voltage, upon each trigger the timer outputting a multi-bit timer value having at least four bits, wherein recording the timer values comprises placing the four least significant bits of each timer value into non-volatile memory within the decoder, and wherein combining the timer values defining the key comprises combining the four least significant bits of twenty timer values defining an 80-bit key.

In another embodiment, the method further comprises wherein activating and deactivating an input line comprises pressing and releasing a switch in electrical communication between the input line and a voltage source.

In another embodiment, the method further comprises wherein triggering a timer upon each rise and fall of voltage on the input line, upon each trigger the timer outputting a multi-bit timer value comprises triggering an 8-bit timer upon each rise and fall of voltage on the input line, upon each trigger the timer outputting an 8-bit timer value, wherein recording the timer value bits comprises recording the last two bits of each of the 8-bit timer values, and wherein combining the timer values comprises combining the last two bits of each of the 8-bit timer values.

In an embodiment, a method of generating and communicating an encryption key between an encoder and a decoder of a wireless remote control system is provided, comprising, generating an encryption key in a decoder, comprising, activating and deactivating an input line on the decoder between high and low voltage one or more times, triggering a timer upon each rise and fall of voltage on the input line, upon each trigger the timer outputting a multi-bit timer value, recording the timer values to memory, and combining the timer values defining the key, and communicating the key to the encoder.

In another embodiment, the method further comprises wherein recording the timer values comprises recording a plurality of low-order bits of each of the timer values.

In another embodiment, the method further comprises wherein activating and deactivating an input line between high and low voltage one or more times comprises activating and deactivating an input line between supply voltage and ground voltage ten times, wherein triggering a timer upon each rise and fall of voltage on the input line, upon each trigger the timer outputting a multi-bit timer value comprises triggering a timer each time the input line goes from low to high voltage and from high to low voltage, upon each trigger the timer outputting a multi-bit timer value having at least four bits, wherein recording the timer values comprises storing the four least significant bits of each timer value into decoder non-volatile memory within the decoder, and wherein combining the timer values defining the key comprises combining the four least significant bits of twenty timer values defining an 80-bit key, and storing the key in the decoder non-volatile memory.

In another embodiment, the method further comprises wherein activating and deactivating an input line comprises pressing and releasing a switch in electrical communication between the input line and a voltage source.

In another embodiment, the method further comprises generating a one or more bit user identification number in the decoder by adding one to the highest current user identification number value stored in decoder non-volatile memory, the user identification number suitable for establishing a unique association of the encoder with the decoder.

In another embodiment, the method further comprises generating a one or more bit user identification number based on the memory location of the value stored in decoder non-volatile memory, the user identification number suitable for establishing a unique association of the encoder with the decoder.

In another embodiment, the method further comprises generating a counter value and storing the counter value in decoder non-volatile memory.

In another embodiment, the method further comprises providing a one or more bit preamble and a one or more bit checksum and storing the preamble and checksum in decoder non-volatile memory, the checksum value suitable for error detection by the decoder.

In another embodiment, the method further comprises wherein communicating the key to the encoder comprises generating a key packet including combining the preamble, the user identification number, the counter value, the key, and the checksum, and communicating the key packet to the encoder.

In another embodiment, the method further comprises wherein communicating the key packet to the encoder comprises communicating the key packet to the encoder utilizing an asynchronous link between the encoder and decoder adapted to transfer the key packet from the decoder to the encoder.

In another embodiment, the method further comprises storing in the decoder non-volatile memory the identification number corresponding to the particular encoder, and storing in decoder non-volatile memory control permissions corresponding to that particular encoder for one or more input lines on the decoder, the control permissions adapted to permit activation of the one or more corresponding output lines on the decoder where the permission is granted and prevent activation of the one or more corresponding output lines where the permission is not granted.

In an embodiment, a wireless remote control system is provided, including a decoder comprising an input line, voltage means adapted to supply a voltage, a switch in electrical communication between the input line and the voltage means, the switch adapted to supply voltage to the input line upon the closing of the switch, a timer in electrical communication with the input line, the timer adapted to sense the state of the input line and output a multi-bit timer value upon sensing a voltage or not sensing a voltage, and decoder non-volatile memory in communication with the timer, the decoder non-volatile memory adapted to store one or more bits of each multi-bit timer value and combine them with any previously stored bits of multi-bit timer values defining a key.

In another embodiment, the system further comprises an encoder, the encoder comprising encoder non-volatile memory, and encoder communicator means for communicating with the encoder non-volatile memory, the decoder further comprising decoder communicator means for communicating with the decoder non-volatile memory, the decoder adapted to communicate the contents of the decoder non-volatile memory to the encoder non-volatile memory via the decoder communicator means for communicating with the decoder non-volatile memory and the encoder communicator means for communicating with the encoder non-volatile memory.

In another embodiment, the system further comprises wherein the decoder communicator means for communicating with the decoder non-volatile memory and the encoder communicator means for communicating with the decoder non-volatile memory comprises electrical contacts for temporary coupling therebetween.

In another embodiment, the system further comprises wherein the decoder communicator means for communicating with the decoder non-volatile memory includes an infrared transmitter and the encoder communicator means for communicating with the decoder non-volatile memory includes an infrared receiver.

In another embodiment, the system further comprises generator means for generating a one or more bit user identification number in the decoder by adding one to the highest current user identification number value stored in the decoder non-volatile memory, the user identification number suitable for establishing a unique association of the encoder with the decoder.

In another embodiment, the system further comprises generator means for generating a one or more bit user identification number based on the memory location of the value stored in decoder non-volatile memory, the user identification number suitable for establishing a unique association of the encoder with the decoder.

In another embodiment, the system further comprises a counter for generating a counter value and storing the counter value in the decoder non-volatile memory.

In another embodiment, the system further comprises storage means for storing a preamble and checksum in the decoder non-volatile memory, the checksum value suitable for error detection by the decoder.

In another embodiment, the system further comprises wherein encoder communicator means for communicating the key to the encoder comprises, means for generating a key packet including combining the preamble, the user identification number, the counter value, the key, and the checksum, and means for communicating the key packet to the encoder.

In another embodiment, the system further comprises wherein the encoder communicator means for communicating the key packet to the encoder comprises encoder communicator means for communicating the key packet to the encoder utilizing an asynchronous link between the encoder and decoder adapted to transfer the key packet from the decoder to the encoder.

In another embodiment, the system further comprises wherein the decoder is a first decoder, wherein the encoder comprises storage means for storing an identification number in the encoder non-volatile memory, and wherein the first decoder comprises means for setting control permissions, storage means for storing in the first decoder an identification number corresponding to the encoder, and storage means for storing in the first decoder control permissions corresponding to the encoder for one or more output lines on the decoder, the control permissions adapted to permit activation of a corresponding output line on the decoder where the permission is granted, and prevent activation of a corresponding output line where the permission is not granted, wherein the decoder responds to the reception of a valid command from the encoder based on whether the command is allowed by the permissions retained in non-volatile memory.

In another embodiment, the system further comprises a second decoder, the second decoder comprising, storage means for storing an identification number and control permissions for the encoder, and decoder communicator means for communicating with the first decoder suitable to transfer the identification number and control permissions from the first decoder to the second decoder.

In another embodiment, the system further comprises wherein the encoder comprises, storage means for storing a personal identification number in the encoder, and transmitter means for communication via a transmitter based upon the entering of the personal identification number prior to attempting to transmit a command.

In another embodiment, the system further comprises an adjustable timer, wherein communication via the transmitter is based upon the user entering the personal identification number prior to attempting to communicate via the transmitter, and is allowed for the amount of time set by the adjustable timer.

In another embodiment, the system further comprises wherein the decoder comprises, communicator means for outputting an identification number associated with the encoder.

In another embodiment, the system further comprises the decoder further comprising non-volatile memory for storing a key, current counter value, and control permissions for a specific encoder, means for identifying the memory location where the key, current counter value, and control permissions for a specific encoder are stored, and decoder communicator means for communicating the memory location as a means for identifying the corresponding encoder.

In another embodiment, the system further comprises a transmitter adapted for electrical communication with the encoder, and activator means for activating the transmitter only when data is to be sent wherein an encoder output line is in electrical communication with the voltage source of the transmitter.

In another embodiment, the system further comprises a receiver adapted for electrical communication with the decoder, and activator means for activating the receiver for a predetermined period of time, monitor means for monitoring for a valid data transmission, and control means for powering down the receiver for a predetermined period of time.

In another embodiment, a remote control system including a decoder product is provided including a decoder, comprising an input line, voltage means for supplying a voltage, a switch in electrical communication between the input line and the voltage means for supplying a voltage, the switch adapted to supply voltage to the input line upon the closing of the switch, a timer in electrical communication with the input line, the timer adapted to sense the state of the input line and output a multi-bit timer value upon sensing a voltage or not sensing a voltage, and decoder non-volatile memory in communication with the timer, the decoder non-volatile memory adapted to store one or more bits of each multi-bit timer value and combine them with any previously stored bits of multi-bit timer values defining a key.

In another embodiment, the system further comprises an encoder product including an encoder, the encoder comprising encoder non-volatile memory, and encoder communicator means for communicating with the encoder non-volatile memory, the decoder further comprising decoder communicator means for communicating with the decoder non-volatile memory, the decoder adapted to communicate the contents of the decoder non-volatile memory to the encoder non-volatile memory via the encoder communicator means for communicating with the decoder non-volatile memory and the decoder communicator means for communicating with the encoder non-volatile memory.

In another embodiment, the system further comprises wherein the decoder communicator means for communicating with the decoder non-volatile memory and the encoder communicator means for communicating with the decoder non-volatile memory comprises electrical contacts for temporary coupling therebetween.

In another embodiment, the system further comprises wherein the decoder communicator means for communicating with the decoder non-volatile memory includes an infrared transmitter and the encoder communicator means for communicating with the decoder non-volatile memory includes an infrared receiver.

In another embodiment, the system further comprises wherein the encoder product further comprises transmitter means for transmitting and receiving radio frequency signals, and wherein the decoder product further comprises transmitter means for transmitting and receiving radio frequency signals, the encoder product and decoder product adapted to communicate with each other via the respective transmitter means for transmitting and receiving radio frequency signals.

In another embodiment, the system further comprises wherein the respective transmitter means for transmitting and receiving radio frequency signals comprises a radio frequency transceiver.

In another embodiment, the system further comprises wherein the encoder product further comprises transmitter means for transmitting radio frequency signals, and wherein the decoder product further comprises receiver means for receiving radio frequency signals, the encoder product and decoder product adapted to communicate with each other via the respective transmitter and receiver.

In another embodiment, the system further comprises wherein the respective transmitter means for transmitting and receiving radio frequency signals comprises a radio frequency transmitter and receiver, respectively.

In an embodiment, a decoder microchip is provided comprising means for checking the logic state of encoder input lines and assembling these states into a command byte, means for storing the command byte, an authentication value, and a counter value, means for combining the command byte, the authentication value, and counter value into an n-bit data block, means for encrypting the n-bit data block forming an encrypted data block, and means for decrementing the counter and encrypting the data block upon each packet transmission.

In an embodiment, a method of communications between an encoder and a decoder is provided, the decoder, comprising determining control permissions for each of one or more decoder output lines on the decoder for the encoder, wherein the control permissions includes allowing or denying activation of the respective decoder output line, and storing the control permissions in decoder non-volatile memory, wherein the decoder responds to the reception of a valid command based on the control permissions retained in the decoder non-volatile memory.

In another embodiment, the method further comprises wherein storing the control permissions in decoder non-volatile memory, wherein the decoder responds to the reception of a valid command based on the control permissions retained in the decoder non-volatile memory, comprises, storing in decoder non-volatile memory an identification number corresponding to the encoder, and storing in decoder non-volatile memory the control permissions corresponding to the encoder for the one or more output lines on the decoder, the control permissions adapted to permit activation of a corresponding output line on the decoder where the permission is granted and prevent activation of a corresponding input line where the permission is not granted.

In an embodiment, a system including an encoder and a first decoder is provided, wherein the encoder comprises means for storing an identification number in the encoder; and wherein the first decoder comprises, means for setting control permissions, means for storing in the first decoder an identification number corresponding to the encoder, and means for storing in the first decoder control permissions corresponding to the encoder for the one or more output lines on the decoder, the control permissions adapted to permit activation of a corresponding output line on the decoder where the permission is granted and prevent activation of a corresponding input line where the permission is not granted, wherein the decoder responds to the reception of a valid command from the encoder based on whether the command is allowed by the permissions retained in non-volatile memory.

In another embodiment, the system further comprises a second decoder, the second decoder comprising means for storing an identification number and control permissions for the encoder, and means for communicating with the first decoder suitable to transfer the identification number and control permissions from the first decoder to the second decoder.

In an embodiment, a method of controlling an encoder is provided, comprising storing a personal identification number in encoder non-volatile memory, wherein the encoder allows communication via a transmitter based upon the user entering the personal identification number prior to attempting to communicate via the transmitter, and entering the personal identification number prior to attempting to communicate via the transmitter.

In another embodiment, the method further comprises wherein entering the personal identification number prior to attempting to communicate via the transmitter comprises entering one or more commands within a settable period of time.

In an embodiment, a system including an encoder is provided, wherein the encoder comprises means for storing a personal identification number in the encoder and means for allowing communication via a transmitter based upon the entering of the personal identification number prior to attempting to transmit a command.

In another embodiment, the system further comprises an adjustable timer, wherein communication via the transmitter is based upon the user entering the personal identification number prior to attempting to communicate via the transmitter is allowed for the amount of time set by the adjustable timer.

In an embodiment, a method of identifying an encoder is provided, comprising storing a one or more bit encoder identification number in decoder non-volatile memory that corresponds to a specific encoder, the encoder identification number suitable for establishing a unique association of the encoder with the decoder, and communicating the encoder identification number when a corresponding encoder is communicating with the decoder.

In another embodiment, the method further comprises wherein storing a one or more bit encoder identification number in the decoder non-volatile memory that corresponds to a specific encoder, the encoder identification number suitable for establishing a unique association of the encoder with the decoder comprises generating a one or more bit encoder identification number in the decoder by adding one to the highest current encoder identification number value stored in decoder non-volatile memory, the encoder identification number suitable for establishing a unique association of the encoder with the decoder.

In another embodiment, the method further comprises wherein the encoder identification number is selected from the group consisting of a serial number, address, and user identification number.

In an embodiment, a method of identifying an encoder is provided, comprising generating a one or more bit encoder identification number corresponding to a memory location wherein a key, current counter value, and control permissions for a specific encoder are stored and communicating the encoder identification number when a corresponding encoder is communicating with the decoder.

In an embodiment, a system including an encoder and decoder is provided, wherein the decoder comprises communicator means for outputting an encoder identification number that is associated with the encoder.

In another embodiment, the system further comprises the decoder further comprising non-volatile memory for storing a key, current counter value, and control permissions for a specific encoder identifier means for identifying the memory location where the key, current counter value, and control permissions for a specific encoder are stored, and communicator means for communicating the memory location as a means for identifying the corresponding encoder.

In an embodiment, a method of power control of a transmitter in a system is provided including an encoder and a decoder, comprising activating the transmitter only when data is to be sent wherein an encoder output line is in electrical communication with the voltage source of the transmitter.

In an embodiment, the method a method of power control of a transmitter in a system is provided comprising an encoder and a decoder, comprising activating the receiver of the decoder for a predetermined period of time, monitoring for a valid data transmission, and powering down the receiver for a predetermined period of time.

In an embodiment, a power control system for a transmitter in a system comprising an encoder and a decoder is provided, comprising activation means for activating the transmitter only when data is to be sent wherein an encoder output line is in electrical communication with the voltage source of the transmitter.

In an embodiment, a power control system for a transmitter in a system comprising an encoder and a decoder is provided, comprising activation means for activating the receiver of the decoder for a predetermined period of time, monitor means for monitoring for a valid data transmission, and control means for powering down the receiver for a predetermined period of time.

### BRIEF DESCRIPTION OF THE DRAWINGS

FIG. 1 is a schematic view of a generic wireless control system;

FIG. 2 is an example of the data packet generated by older generation encoders;

FIG. 3 is an example of a data packet generated by second generation encoders;

FIG. 4 is an example of a generic microcontroller;

FIG. 5 is a flow diagram of a method for creating a key in a decoder in accordance with an embodiment;

FIG. 6 is a flowchart of a method for communicating a key packet to the encoder, in accordance with an embodiment;

FIG. 7 is a flow diagram of a method for learning button level permissions in the decoder in accordance with an embodiment;

FIG. 8 is a flow diagram of a method for creating a PIN in accordance with an embodiment;

FIG. 9 is a flow diagram of a method for testing a PIN in accordance with an embodiment;

FIG. 10 is a flow diagram of a method for sending a transmission in accordance with an embodiment;

FIG. 11 is a flow diagram of a method for sending a copy of data in accordance with an embodiment;

FIG. 12 is a flow diagram of a method for receiving a copy of data in accordance with an embodiment;

FIG. 13 is a flow diagram of a method for controlling receiver power in accordance with an embodiment;

FIG. 14 is a flow diagram of a method for encrypting data using an encryption protocol in accordance with embodiments;

FIG. 16 is a flow diagram of a method for encrypting data using an encryption protocol in accordance with an embodiment; and

FIG. 18 is a flow diagram of a method for decrypting data using a decryption protocol in accordance with an embodiment;

FIG. 19 is a flow diagram of a method of operation of an encoder, in accordance with embodiments;

FIG. 20 is a flow diagram of a method of operation of a decoder, in accordance with embodiments; and

FIG. 21 is a schematic view of an embodiment of a wireless control system, in accordance with an embodiment.

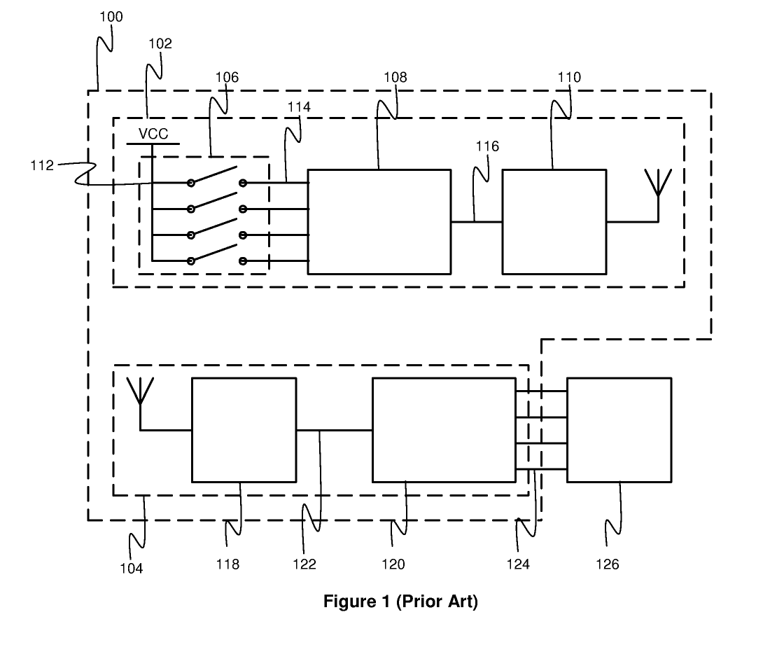

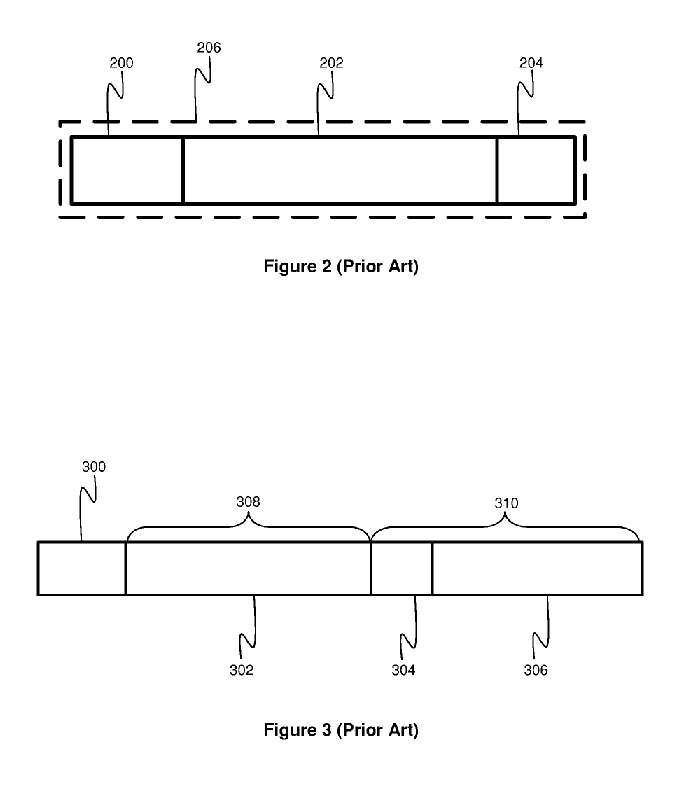

### DETAILED DESCRIPTION

In the following detailed description, reference is made to the accompanying drawings, which form a part hereof wherein like numerals designate like parts throughout, and in which is shown by way of illustration specific embodiments in which the invention may be practiced. It is to be understood that other embodiments may be utilized and structural or logical changes may be made without departing from the scope. Therefore, the following detailed description is not to be taken in a limiting sense, and the scope is defined by the appended claims and their equivalents.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Embodiments in accordance with the present invention provide remote control encoders and decoders, encryption algorithms, systems and methods, singularly and in combination, and not limited thereto, suitable for a particular purpose.

The encoder and decoder may be of any suitable electronic device, including, but not limited to, physical circuitry and software manifestations of physical circuitry, and combinations thereof. As will be appreciated by those skilled in the art, the functions of the encoder and decoder can be implemented in dedicated logic, although a microcontroller or microprocessor based implementation is anticipated.

In accordance with an embodiment, the encoder and decoder described herein are implemented in a microcontroller in the form of a Shrink Small Outline Package (SSOP), which is a packaging technology that is well known in the semiconductor packaging art.

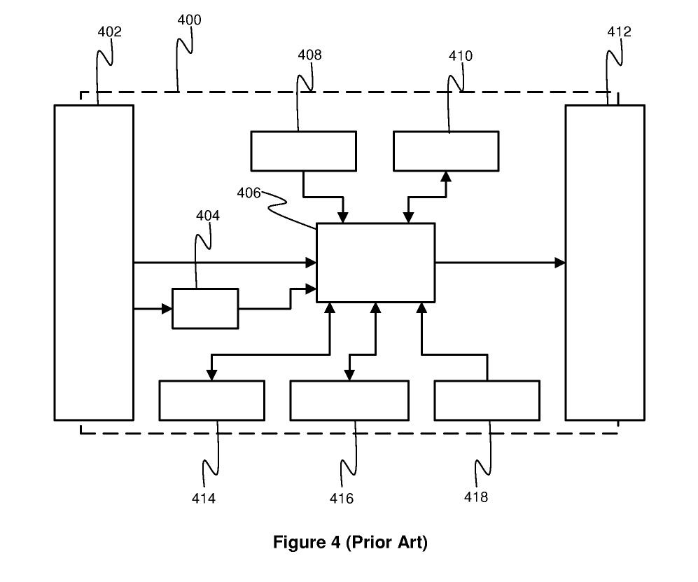

FIG. 4 is an example of a generic microcontroller 400, as is known in the art. The microcontroller 400 comprises a Central Processing Unit (CPU) 406, which is the computer that executes instructions contained within the program. A clock 408 provides the timing signal for the CPU 406. Most microcontrollers 400 on the market have an internal oscillator to generate the clock timing signal, but can also be connected to an external clock source if a faster or more accurate signal is required. Timers 410 are set by the CPU 406 to time specific events within the program. There are three types of memory commonly contained within a microcontroller 400. Random Access Memory (RAM) 414 is used to store the results of calculations performed by the CPU 406 based on the instructions it is executing at the moment. This memory is volatile, so if power is removed, everything stored in RAM will be lost. EEPROM 416 is similar to RAM, but it will retain its memory if power is removed. This is where long-term values, such as the address or serial number data, will be stored. Flash Read Only Memory (ROM) 418 is where the program and instructions for the CPU 406 are stored. Interface to external circuitry is provided by input ports 402 and output ports 412. These ports are connected to the individual pins on the microcontroller's package. Input ports 402 take information from external circuitry and send it to the CPU 406. Output ports 412 take information from the CPU 406 and send it to external circuitry. Some ports can often be defined as input or output by the program and can also be changed from one to the other during program execution. Interrupts 404 can be provided between the input ports 402 and the CPU 406 to alert the CPU 406 when new information is being provided from external circuitry. The input and output ports 402, 412 frequently contain peripheral devices, such as, but not limited to, serial ports (UART, USART, SPI, IIC), comparators, and Analog to Digital Converters (ADC). There are many different microcontrollers with various combinations of memory size, peripheral devices, and microprocessor architectures.

“Instructions” as referred to herein relate to expressions which represent one or more logical operations. For example, instructions may be “machine-readable” by being interpretable by a machine for executing one or more operations on one or more data objects, such as, for example, a processor. However, this is merely an example of instructions and claimed subject matter is not limited in this respect. In another example, instructions as referred to herein may relate to encoded commands which are executable by a processor or other processing circuit having a command set which includes the encoded commands. Such an instruction may be encoded in the form of a machine language understood by the processor or processing circuit. Again, these are merely examples of an instruction and claimed subject matter is not limited in these respects.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical and/or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based at least in part on one or more input signals. Such circuitry may comprise a finite state machine which receives a digital input signal and provides a digital output signal, or circuitry which provides one or more analog output signals in response to one or more analog input signals. Such circuitry may be provided, for example, in an application specific integrated circuit (ASIC) and/or a field programmable gate array (FPGA). Also, logic may comprise machine-readable instructions stored in a storage medium in combination with a processor or other processing circuitry to execute such machine-readable instructions. However, these are merely examples of structures which may provide logic and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “querying,” “obtaining,” “maintaining,” “representing,” “modifying,” “receiving,” “transmitting,” “storing,” “authenticating,” “authorizing,” “determining” and/or the like refer to the actions and/or processes that may be performed by a computing platform, such as a computer, microcontroller, or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

“Transmitter” as referred herein relates to a device for sending data via a mode of transmission or communication. The mode of transmission or communication includes, but is not limited to, radio frequency (RF), infrared (IR), and electrical contact. These are merely examples of a mode of communication and claimed subject matter is not limited in these respects.

“Transmitter product” as referred herein relates to a device that comprises a transmitter, encoder, and switching unit.

“Receiver” as referred herein relates to a device for receiving data communicated from a transmitter via a mode of transmission or communication. The mode of transmission or communication is as described for the transmitter.

“Receiver product” as referred herein relates to a device that comprises a receiver and decoder.

“Encryption” as referred herein relates to a process of obscuring data so as to make it unreadable to someone without a special knowledge of how to unobscure it.

“Encryption function”, “encryption algorithm”, and “cipher”, as referred herein, relate to an algorithm used for encryption.

“Encryption protocol” as referred herein relates to a process of using an encryption function to encrypt data, including any pre- and post-data manipulation done by a system.

“Data block” as referred herein relates to that portion of a data packet that is encrypted, such as, but not limited to, a command byte, a counter value, and an authentication pattern, or combinations thereof.

“Data packet” as referred herein relates to data that is combined and transmitted or communicated as a distinct set, such as, but not limited to, an identifier and a data block, and combinations thereof.

“Data stream” as referred herein relates to a series of data packets that are output one after the other to the transmitter. The data packets in the stream may be unrelated to each other or may be the same data packet sent repeatedly.

“Message” as referred herein relates to two or more associated data packets that are output from the encoder.

“High” as referred herein is in reference to the voltage state of input and output lines. High refers to relative high voltage in a circuit including the input or output lines, such as, but not limited to, a supply voltage (Vcc). High is also referred to as a logic ‘1’.

“Low” as referred herein is in reference to the voltage state of input and output lines. Low refers to relative low voltage in a circuit including the input or output lines, such as, but not limited to, circuit ground (GND). Low is also referred to as a logic ‘0’.

### Unique Key Creation

The encoder of a secure remote control system uses an encryption algorithm, also called a cipher, to alter the data sent by the encoder. The decoder uses an associated decryption algorithm to recover the original data. Encryption algorithms are complex mathematical functions that use a number called a key to alter the data. One hallmark of a good encryption protocol is the secrecy of the key, not the algorithm itself. In other words, an attacker can know everything about the algorithm that is used in a system, but will still not be able to recover the data without the correct key.

In accordance with an embodiment, a key is created by the user by toggling a decoder input line on the decoder between high and low voltage a predetermined number of times. Key creation can be provided by the encoder and transferred to the decoder, but, as can be appreciated by those skilled in the art, creating a key in the encoder can result in vulnerabilities in the security of the system.

A high-speed timer is triggered by each rise and/or fall, or both, of voltage on the decoder input line, and the time that the line is high and low is recorded. The key is generated by combining a predetermined number of low-order bits of the resulting timer values until the key is filled. The low-order bits are those bits that change most frequently as the timer changes.

In an embodiment of a method, wherein a push button switch is provided in communication with the decoder input line, activations and deactivations (toggling) correspond to button presses and releases. The length of time a user presses the button is a very random event, especially when a high-resolution timer is employed. This results in a key that is generated randomly from among all possible keys and each of the bits of the key are chosen uniformly, equally likely to be a 0 or a 1, and independently, in that the value of any bit does not depend on what was chosen for any of the other bits. This approach to generating a random number is superior to a deterministic source, such as an implementation of a non-cryptographic random number generator like a linear feedback shift register. This approach is far superior to having the manufacturer of the encoder and decoder provide a list of keys to equipment manufacturers who are using those encoders and decoders in their own end products.

In accordance with an embodiment the decoder input line is toggled between high and low, from supply to ground, 10 times to create an 80-bit key. Each time the decoder input line goes from low to high (rising edge) or from high to low (falling edge), the timer is triggered. On each trigger, the four least significant bits of the timer value are placed into decoder memory where the key is stored. The 80-bit key is generated by combining the four least significant bits of the twenty timer values. The key is stored in non-volatile memory within the decoder and is transferred to the encoder's non-volatile memory, as will be further described below.

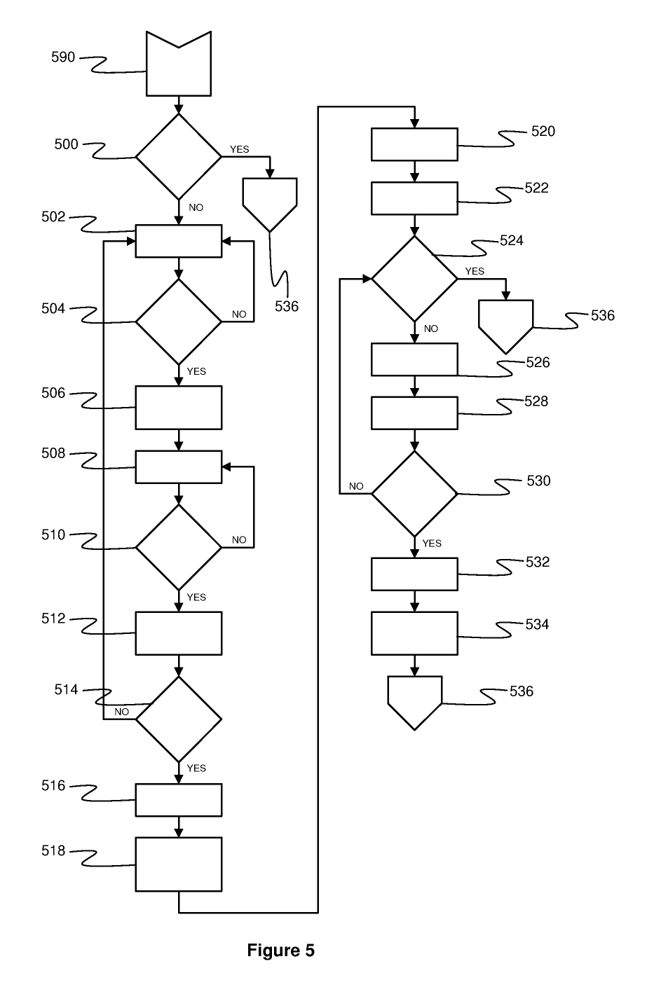

FIG. 5 is a flow diagram of a method for creating a key 590 in a decoder, in accordance with an embodiment. The decoder determines if it is a copy 500 (this will be described further below). If it is a copy, the operation is aborted and the decoder goes to sleep 536. If it is not a copy, the decoder starts incrementing a high-speed counter 502. In accordance with an embodiment, a sequence is started when a decoder input line, referred to as the CREATE_KEY line, is taken high. The decoder checks to see if the CREATE_KEY line is low 502. The decoder continues incrementing the high-speed counter 502 until the CREATE_KEY line is taken low 504. If the CREATE_KEY line is low, the decoder stores the four least significant bits of the counter value in memory where they are added to the key 506. The decoder continues to increment the counter 508 until the CREATE_KEY line is taken high 510. The decoder stores the four low-order bits in memory, adds them to the key 512, and checks to see if the key is complete 514. The process repeats until the key has been completed.

Once the key has been completed, the decoder determines a user ID 516. The user ID is a unique identifier that the encoder sends with every message. The decoder associates this identifier with the key that the encoder used to encrypt the message (discussed in more detail later). The user ID is determined by incrementing the current number of users saved in memory by one. For example, if two encoders have already been associated, this encoder will have a user ID of three. The control permissions and counter are set to initial values 518 and a key packet is created 520. In accordance with an embodiment, the key packet consists of a preamble, the user ID, the counter value, the key, and a checksum that is used for error detection by the encoder. The key packet is transferred to an encoder to create an association as described below.

### Associating an Encoder and Decoder by Exchanging a Key Packet

In accordance with an embodiment of a method, an association is created between an encoder and decoder by transferring the key packet, which contains the user ID, an initial value for the counter, and the key, to the encoder via a wire, contacts, IR, or other secure serial connection, thus storing the same key on both the encoder and decoder. This allows the end user or manufacturer to create associations between the encoder and decoder. If the encoder and decoder have been associated through a successful key exchange, the decoder will respond to the encoder's commands based. If an encoder has not been associated with a decoder, its commands will not be recognized.

In accordance with an embodiment of the method, the key exchange utilizes a bidirectional link between the encoder and decoder. The key is first generated in the decoder by the user as described above. Referring again to FIG. 5 and continuing the explanation from the previous section, once the key packet is created 520, the decoder starts a timer 522. The decoder checks to determine if the timer runs out before the decoder receives confirmation that the key packet was received successfully 524. If the timer runs out, the decoder goes to sleep 536. If the timer has not run out, the decoder outputs the key packet 526 on a decoder output line, called the KEY_OUT line, as a serial data stream. This packet is transferred to the encoder over a secondary link using any method of sending serial data, such as, but not limited to, a wire, contact points on an enclosure, infrared, or RF. RF is less secure as it broadcasts in all directions and can compromise the security of the system. Infrared is suitable for relatively secure wireless transfer as it has very short range and is directional.

Referring again to FIG. 5, the decoder receives confirmation from the encoder 528 and checks if the encoder did confirm that the key packet was received successfully 530. If the encoder dies confirm that the key packet was received successfully, the decoder sends a final confirmation to the encoder on the KEY_OUT line 532 and writes the user ID, counter, and key to non-volatile memory 534. The decoder goes to sleep 536.

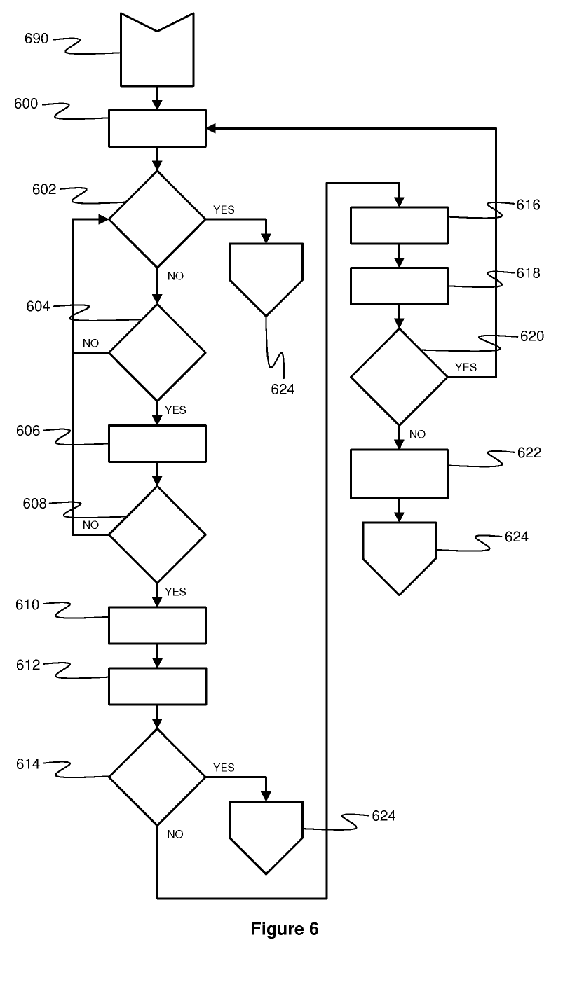

FIG. 6 is a flowchart of a method for communicating a key packet to an encoder 690, in accordance with another embodiment. When the encoder registers activity on an encoder input line, referred to as the KEY_IN line, it starts a timer 600 and checks to see if it has timed out 602. If the timer has not timed out 602, the encoder looks for a key packet from the decoder 604. The encoder tests the preamble 606, 608 to make sure that it matches a predetermined pattern and that there are no errors. If the preamble is valid, it receives the key packet 610. The encoder calculates a checksum for the key packet 612 and compares that value to a checksum received in the key packet 614. If the values match, the key packet is accepted and a confirmation is output on an encoder output line 616, referred to as the DATA line. The confirmation is checked for errors by the encoder 618, 620, and if the decoder's confirmation is received successfully, the encoder writes the user ID, counter, and key to its non-volatile memory 622. Once the Get key process is complete, if there are any errors, or if the timer runs out, the encoder goes to sleep 624.

### Control Permissions

In accordance with an embodiment, the decoder is adapted such that the user or manufacturer may set “button level” control permissions. Control Permission settings determine how the decoder will respond to the reception of a valid command, either allowing the activation of a particular output line or not. The decoder is programmed with the permission settings during set-up, and those permissions are retained in the decoder's non-volatile memory.

This allows the manufacturer or end user to decide which individual decoder output lines a specific encoder will be allowed to access. By way of example, but not limited thereto, a building access system is provided such that an assembly line worker's transmitter product (keyfob) will only open the door to the factory floor, controlled by a receiver product. The manager's transmitter product will open the door to the factory floor and the offices. The CEO's transmitter product will open all of the doors in the factory. All of the transmitter products are identical, but the control permissions have been set differently for each transmitter product.

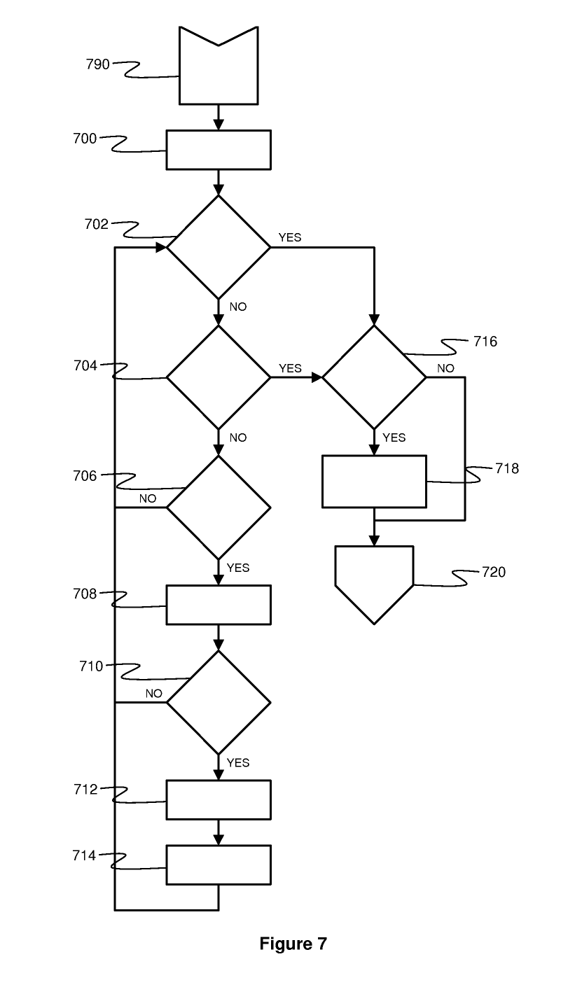

Before the control permissions can be set, the key must have been generated in the decoder and transferred to the encoder. For security, the encoder's initial control permissions are set to give it no access to the decoder with which it has been associated. FIG. 7 is a flow diagram of a method for the encoder to learn button level permissions from the decoder 790, in accordance with an embodiment. This method is executed by toggling a decoder input line on the decoder, referred to as the LEARN line. A timer is started 700. The state of the timer is checked 702. If the timer has not timed out, the state of the LEARN line 704 is checked. If the timer runs out or the LEARN line is high, the mode is terminated. If the LEARN line is low, the decoder looks for data from an associated encoder 706. If there is data present on the decoder DATA input line, the data is received 708. The validity of the data is checked 710. If the data is validated, the encoder input lines that were activated, as indicated by the command byte, are added to the control permissions 712 and a flag is set to indicate that valid data was accepted 714.

Each encoder input line that the encoder will be allowed to access is activated. The encoder determines the logic states of its encoder input lines and creates a command byte that represents these states. This command byte is part of the message that is communicated to the decoder. The decoder will loop back to check the timer 702 and the state of the LEARN line 704. As the decoder receives commands to take output lines high, the activations are stored in memory and those lines are added to the control permissions. If the timer runs out or the LEARN line is taken high, the decoder checks the flag to see if any valid data was accepted 716. If there is valid data, the control permissions will be saved in non-volatile memory 718 and the decoder will go to sleep 720.

### Encoder Personal Identification Number

In accordance with an embodiment, the encoder further comprises means for operation under the control of a Personal Identification Number (PIN). Without PIN control, if an unauthorized person gains access to an authorized encoder, the system can be compromised without needing to break the encryption. To help protect against this, the encoder can be set to require a PIN to be entered before it will begin any operation. The PIN is a combination of encoder input line activations that must be entered before the encoder will transmit any commands to the decoder. This combination of encoder input line activations can be set by the end user or equipment manufacturer. When entered, the encoder will be active for a period of time before the PIN needs to be entered again. This period of time can be set by the end user or equipment manufacturer.

In an embodiment, the user can set a PIN that is a combination of activations of any four encoder input lines on the encoder. This same combination will need to be entered to activate the encoder. Once entered, the encoder will be active for a predetermined amount of time, such as by way of example, thirty seconds or fifteen minutes, based on the state of a particular encoder input line.

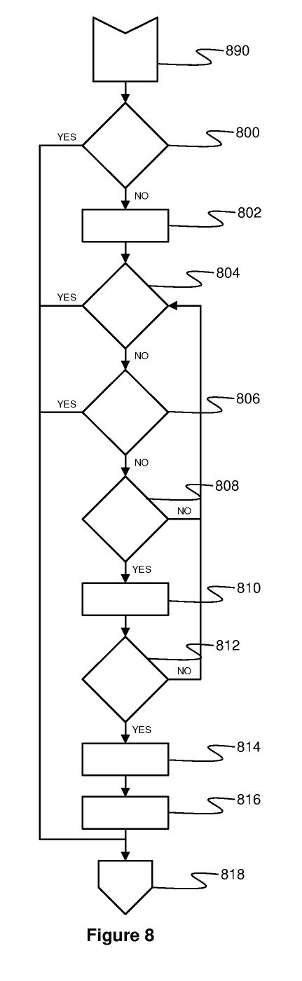

FIG. 8 is a flow diagram of a method for creating a PIN 890 in accordance with an embodiment. This sequence is begun by toggling the logic state of an encoder input line, referred to as the CREATE_PIN line, high, then low. The encoder checks to see if a PIN has already been created 800. If yes, it goes to sleep 818. If no, the encoder begins a timer 802, enters a loop where it checks for a time out 804, and if not timed out, checks the state of the CREATE_PIN line 806, and if high, checks the states of the encoder input lines 808. If the timer times out or if the CREATE_PIN line is high, the encoder exits the loop and goes to sleep 818. If an encoder input line is activated, the encoder records which encoder input line was activated 810 and checks to see if that was the fourth entry 812. If it was not the fourth entry, it reenters the loop at 804. Once the fourth entry is made, the encoder sets a flag to indicate that a PIN has been created 814, writes the PIN into non-volatile memory 816, and goes to sleep 818.

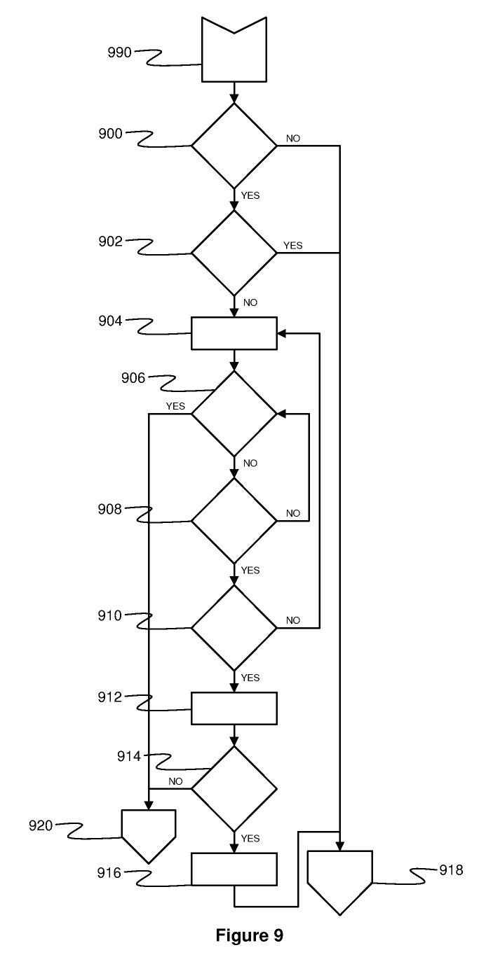

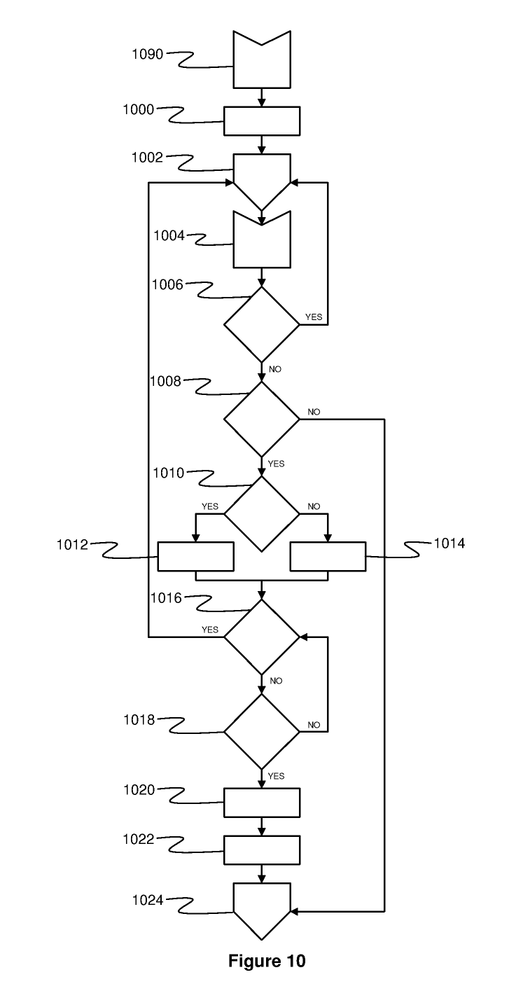

FIG. 9 is a flow diagram of a method for testing a PIN 990 in accordance with an embodiment. When the encoder is activated by activating an encoder input line, the encoder checks to see if the PIN has been enabled 900. If it has not, it proceeds to creating and sending packets 918 (this is shown in FIG. 10 and described below). Otherwise, it checks to see if the PIN is active 902, meaning that it has already been entered. If it is active, the encoder proceeds to creating and sending packets 918. If the PIN is not active, the encoder sets a timer of predetermined duration 904, such as, but not limited to, 2 seconds and enters a loop where it checks the timer 906, and if not timed out, looks for an encoder input line to be activated 908. If an encoder input line is activated, the encoder records that line and checks to see if it is the fourth entry 910. If it is the fourth entry, it reads the PIN from memory 912 and compares it to the PIN that was entered 914. If a match is confirmed, the encoder sets a flag to indicate that the PIN is active 916 and proceeds to create and send packets 918. If the PIN does not match the one in memory, the encoder goes to sleep 920.

It is anticipated that the timer for PIN entry may have a preset predetermined duration, or be user specified. In accordance with an embodiment, the encoder is programmed with multiple timer duration settings that the user may select.

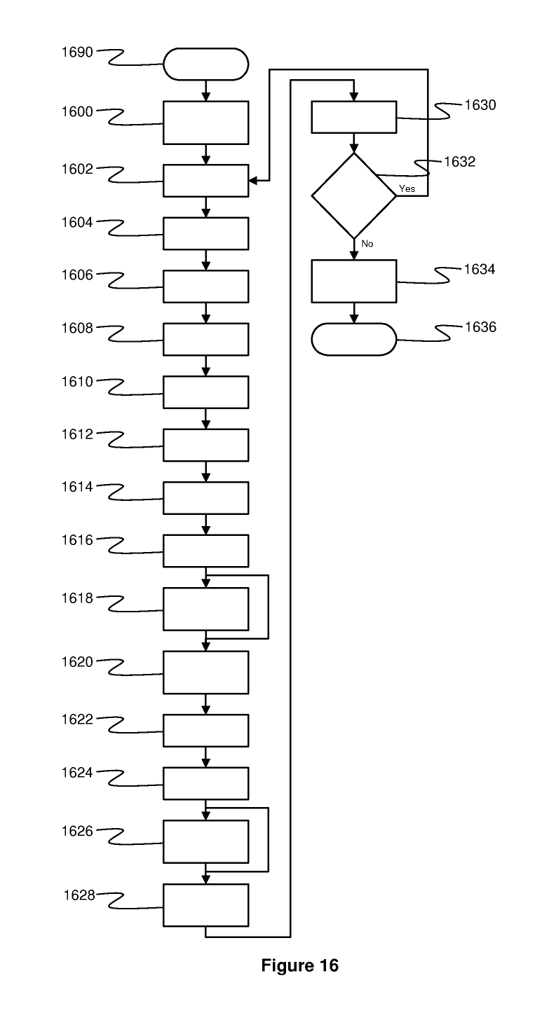

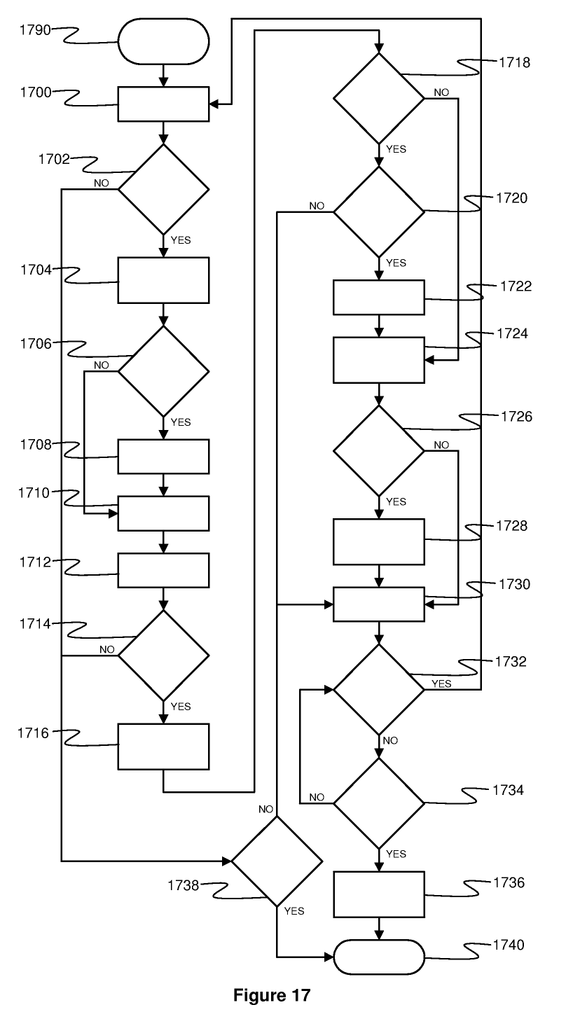

FIG. 10 is a flow diagram of a method for sending a transmission 1090 in accordance with an embodiment. The encoder activates an encoder output line for controlling power to an external transmitter, referred to as the TX_CNTL line 1000 (this is described further below). The encoder encrypts the message 1002 and outputs the message 1004 (this is shown in FIG. 16 and described further below). The encoder sends messages for as long as a particular input line is activated, referred to as the SEND line. The state of activation of the SEND line is checked 1006. If the SEND line is activated, the encoder enters the loop to encrypt the message 1002. If the SEND line is deactivated, the encoder checks to see if the PIN is enabled 1008 and, if yes, checks the logic state of the SEL_TIMER line 1010. The encoder sets a timer to one of two predetermined lengths of time according to the state of the encoder input line. In accordance with an embodiment, the timer is set to 30 seconds if the SEL_TIMER line is high 1012, or fifteen minutes if the SEL_TIMER line is low 1014. The encoder looks for the SEND line to be activated again 1016, and whether the timer has run out 1018. If the timer expires before the SEND line is reactivated, the active PIN flag is cleared 1020, the TX_CNTL line is deactivated 1022, and the encoder goes back to sleep 1024.

### Encoder Identification Output

In accordance with embodiments, the decoder uses an identifier, such as, but not limited to, a serial number, address, or ID, to determine if an encoder is associated or learned therewith. The decoder outputs an identifier for the transmitter product that sent a signal. This enables the receiver product to identify the originating transmitter product and take a predetermined action. By way of example, but not limited thereto, in a hospital the patients can each be given a transmitter product in the form of a keyfob that can be pressed in case of an emergency. When pressed, the decoder will output the ID of the transmitter and the nurses will know who sent the request and to which room they should respond.

In accordance with embodiments, the decoder identifies and outputs a decoder-assigned identification number for a specific encoder. An encoder's key, current counter value, and control permissions (which, as a group, are referred to as user data) are stored in a memory location within the decoder. The decoder outputs a binary number that corresponds to the memory location where the encoder's information is stored. The user data of the first encoder that is learned by the decoder is stored in location number 1, so its ID number will be a binary 1. The user data of the second encoder is saved in location 2, so its ID number will be a binary 2, and so forth. Once the decoder receives a valid signal from an encoder, it outputs the memory location number in which the encoder's user data was stored. The ID number is output asynchronously once after the first message is verified. A personal computer, microcontroller, or other computer can associate this ID with a particular transmitter product.

In an embodiment of the example above, the nurse's station comprises a computer in communication with the decoder that reads the ID and associates it with a room number. If the transmitter product in room 101 was learned first, it gets the ID number 1. The computer reads this ID from the decoder and displays “Room 101” on its screen, and the nurses can attend to the needs of the patient in that particular room.

### Copying a Decoder

In an embodiment, the decoder communicates the contents of the user data of all of the learned encoders saved in memory, including, but not limited to, the control permissions, current counter value, and key to another decoder. This makes it possible to use the same transmitter product, encoder, and control permissions in multiple locations. The decoder outputs all of its user data on a decoder output line for asynchronous transfer to another decoder. The decoder that receives the user data, referred to as the receiving decoder, becomes a copy of the originating decoder and loses the ability to create a key and send a copy. The receiving decoder can only set control permissions until its memory is erased, at which point it regains full functionality, like a new decoder.

In an embodiment, the Copy feature of the originating decoder is disabled by setting two of the decoder input lines high when the decoder is powered on. The decoder is not able to send a copy of its user data again until its memory is cleared. This is a security feature because it will not permit the unauthorized expansion of the system.

The ability to make copies of the decoder is advantageous for a number of applications. For example, but not limited thereto, if a building access system is to have two hundred users who can all use the front and back doors in a building, it would be inconvenient for the system administrator to have two receiving systems each learn two hundred transmitter products. It is simpler for the administrator to learn one system and copy the decoder's learned information to any number of other decoders. Furthermore, it is desirable for the copied decoder to be able to set new control permissions so that access throughout the building can be determined without having to associate every door individually.

The originating and receiving decoders communicate with each other by some means of transferring asynchronous serial data, such as, but not limited to, a wire or short-range infrared. Although it can be used, RF is not recommended for this transfer because it can represent a security risk since RF broadcasts in all directions. A wire is a relatively secure means of transfer. An output line of the originating decoder is coupled to an input line of the receiving decoder and vice versa. The ground lines are coupled together to ensure a common reference, and the data is communicated.

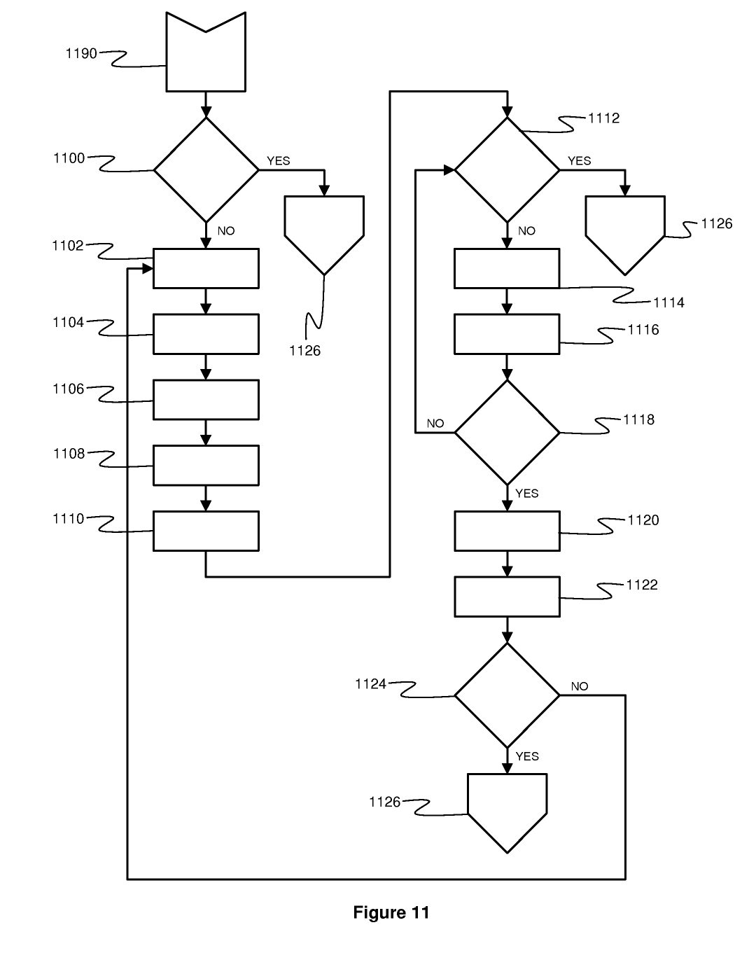

FIG. 11 is a flow diagram of a method for sending a copy of data from an originating decoder 1190 in accordance with an embodiment. Once initiated, the originating decoder determines if it is a copy 1100. If it is a copy, it goes to sleep 1126. Otherwise, it assigns a memory address for the next set of user data 1102. The originating decoder reads the control permissions 1104, counter 1106, and key 1108 from the first memory slot and sets a timer for a predetermined time 1110. If the predetermined time is expired 1112, it goes to sleep 1126. If it has not expired, it sends the user data 1114 on a decoder output line, referred to as the KEY_OUT line, until it receives a confirmation from the receiving decoder 1116 on an input line, referred to as the COPY_IN line. Confirmation is checked 1118, and if a confirmation is received from the receiving decoder, the originating decoder sends a final confirmation 1120 and waits a predetermined time for the receiving decoder to write the user data into memory 1122. The originating decoder checks to see if that was the last user in memory 1124. If that was the last user in memory, the originating decoder goes to sleep 1126. Otherwise, it continues the loop until all of the user data has been sent.

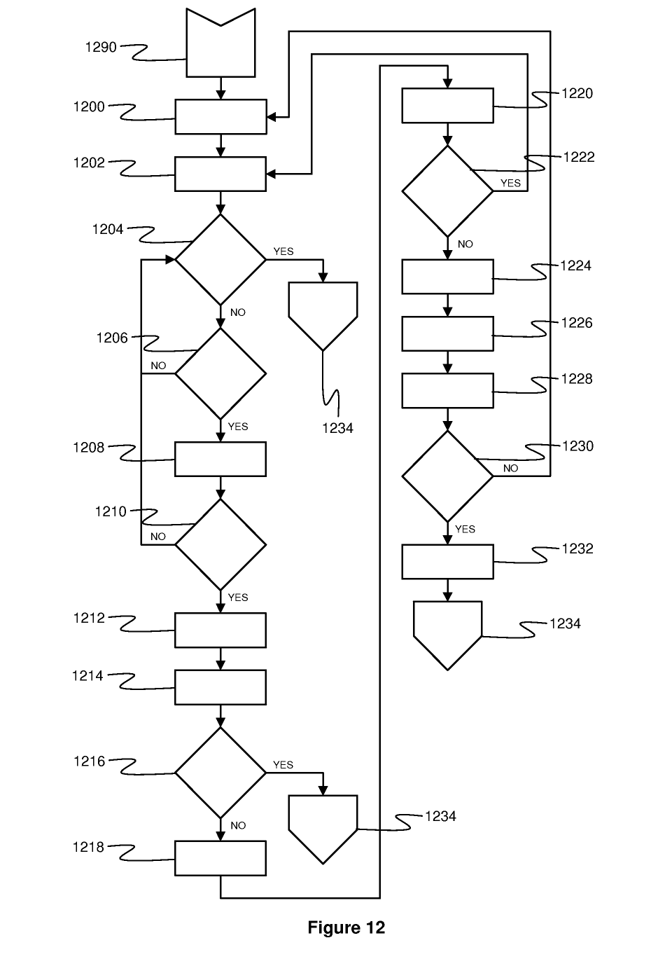

FIG. 12 is a flow diagram of a method for receiving a copy of data by the receiving decoder 1290 in accordance with an embodiment. Once this sequence has begun, the receiving decoder sets the memory address for the next set of user data 1200. The receiving decoder sets a timer 1202 and checks to see if the timer has run out 1204. If the timer times out, it goes to sleep 1234. If the timer has not run out, the receiving decoder looks for data on a decoder input line 1206, referred to as the COPY_IN line. If data is received, the receiving decoder tests the preamble 1208 and determines its validity 1210. If the preamble is valid, the receiving decoder gets the rest of the data 1212 and tests the checksum on the data 1214, and checks of there are errors 1216. If there are errors, the receiving decoder goes to sleep 1234. Otherwise, it sends a confirmation to the originating decoder 1218 on a decoder output line, referred to as the KEY_OUT line. The receiving decoder checks for a confirmation 1220 and determines if there are any errors 1222. If the receiving decoder receives a valid confirmation from the originating decoder on the COPY_IN line, it writes the control permissions 1224, counter 1226, and key 1228 to memory. The memory is checked to see if it is full 1230. If the memory is full, it sets a flag indicating that the receiving decoder is a copy 1232 and goes to sleep 1234. Otherwise, it returns to look for the next set of user data on the COPY_IN line and sets the memory address for the next set of user data 1200.

### Transmitter and Receiver Power Control

In accordance with an embodiment, the encoder and decoder control power to the transmitter and receiver, respectively, by way of an output line. For the encoder, this encoder output line can be connected to the power supply of the transmitter so that the encoder can activate the transmitter only when data is to be sent. This allows the encoder and transmitter to remain off or powered down until needed, greatly reducing current consumption and extending battery life. Referring again to FIG. 10, the encoder activates an output line, referred to as the TX_CNTL line 1000 before sending a message. When the procedure is complete, the encoder deactivates the TX_CNTL line 1022.

The decoder does not know when a transmission will occur, so it cannot wake the receiver only during a transmission. Without the receiver active, the decoder cannot receive any data to know that a transmission is taking place. For this reason, the decoder supplies power to the receiver for a period of time, looks for valid data for a predetermined period of time, and powers down for a period of time. In accordance with an embodiment, the decoder activates a decoder output line, referred to as the RX_CNTL line, for the time required to send one message plus 10 mS for the receiver to power up, so the actual “on” time depends on the baud rate of the transmission of the messages. The baud rate is the speed at which data is sent over the link, measured in bits per second (bps). This time can be calculated in milliseconds as (188/Baud ate)(1000)+14 in accordance with an embodiment. The “off” time is nine times the “on” time, resulting in a 10% power duty cycle. This greatly reduces the receiver product's current consumption and extends battery life.

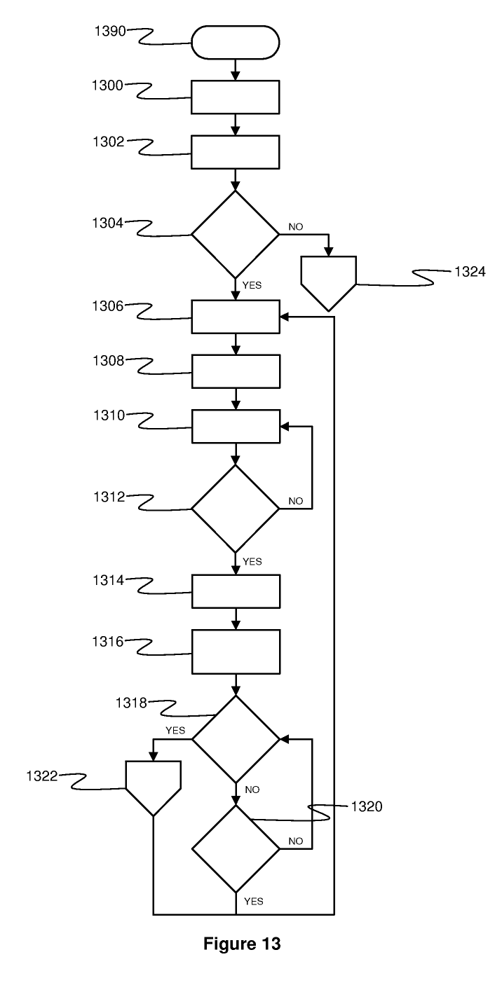

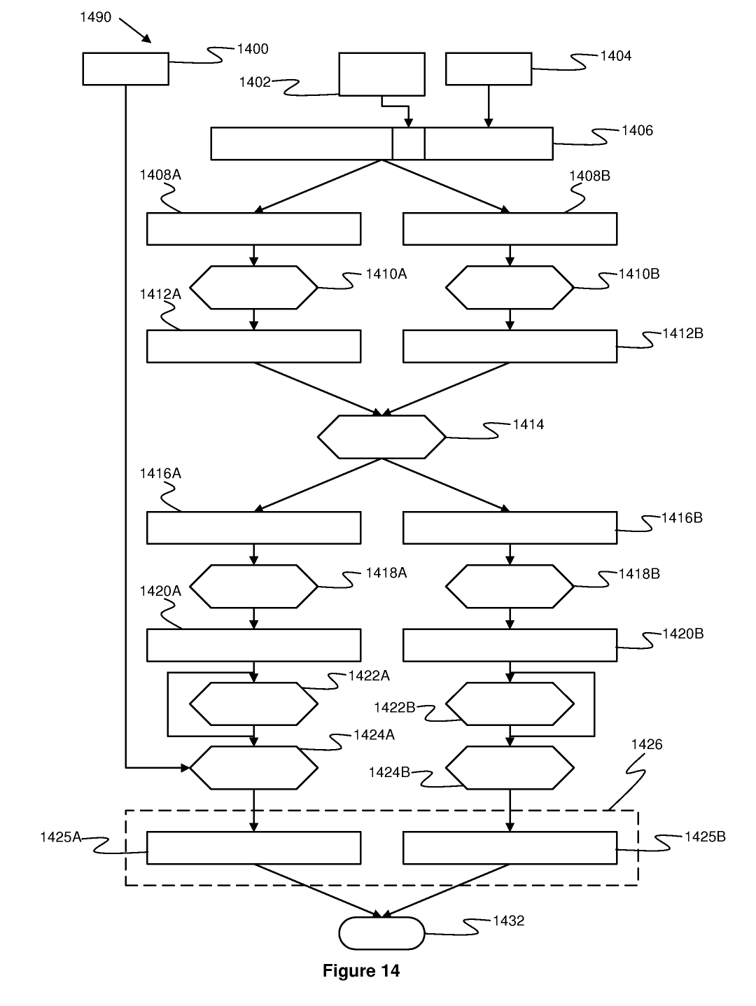

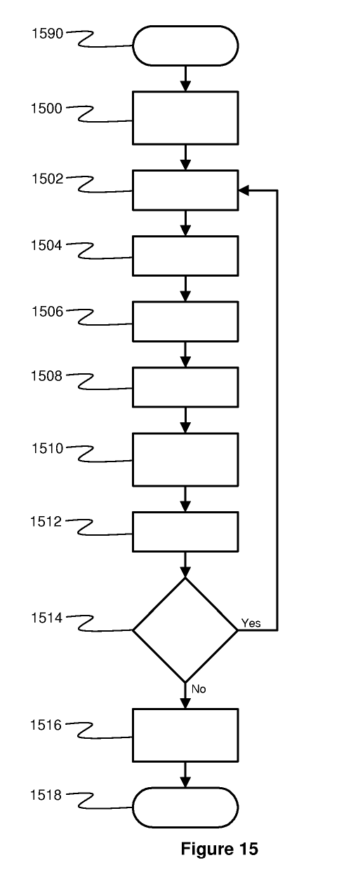

FIG. 13 is a flow diagram of a method for controlling receiver power in accordance with an embodiment. When power is applied to the decoder 1390, it initializes itself 1300 and determines the baud rate for the messages 1302. The decoder determines if receiver power control has been activated 1304. If not, it goes to sleep 1324. If receiver power control is active, the decoder pulls the RX_CNTL line low to deactivate the receiver 1306. The decoder calculates the “on” and “off” times as described above, begins a counter for the “off” time 1308. The counter is decremented 1310 and checked to see if it has run out 1312. If the counter has run out, the decoder activates the RX_CNTL line 1314 and starts a timer for the “on” time 1316. The decoder checks to see if data is detected on the decoder input line 1318. If the decoder detects data on a decoder input line, referred to as the DATA_IN line, the decoder goes to a receive routine 1322. The decoder is active for as long as valid data is being received. The decoder checks to see of the on time has run out 1320. If no data is received by the time the “on” timer runs out, the decoder deactivates the RX_CNTL line 1306, begins the counter for the “off” time 1308, and repeats the loop.

### Encryption in a Remote Control System

In accordance with an embodiment, the encoder determines the logic states of its encoder input lines and creates a command byte X from those states. It assembles a data block comprising an x-bit command byte X, a y-bit counter value C, and a z-bit Authentication pattern A for a total of x+y+z bits. In accordance with an embodiment, the encoder determines the logic states of its encoder input lines and creates a command byte X from those states. It assembles a data block comprising an 8-bit command byte X, a 40-bit counter value C, and an 80-bit Authentication pattern A for a total of 128 bits.

The data block is encrypted using an encryption algorithm, also referred to as a cipher. The encryption algorithm can be any block cipher, such as but not limited to, AES and Skipjack. The amount of data used by a block cipher can be increased by using the block cipher in an encryption mode, such as but not limited to EME, CMC (CBC-Mask-CBC), ECB (electronic code book), or CBC (Cipher-Block Chaining).

In accordance with an embodiment, the encryption algorithm used in the encoder is based on a cipher known as “Skipjack,” which was designed by the U.S. National Security Agency. Skipjack is a block cipher with 80-bit keys and 64-bit data blocks. Because each data block created by the encryption algorithm is longer that 64 bits, Skipjack must be employed in an encryption mode, also referred to as a mode of operation. A mode of operation, referred to as mode, is the way in which individual encrypted blocks of a message are put together to form the complete encrypted message. The algorithm used to combine the encrypted blocks can be just as important to the security of a system as the algorithm used to encrypt the blocks in the first place. There are several different encryption modes known in the art. In accordance with an embodiment, the encryption mode is based on the CMC encryption mode, so that the resulting cipher is a special kind of function known as a “strong Pseudorandom Permutation” (sPRP). The definition of an sPRP is known in the art, but it essentially provides that an adversary is unable to distinguish a given permutation from a random permutation on the same domain when given suitable access to the function and its inverse. In other words, without the key that was used to encrypt the data, an outside observer will not be able to distinguish the encrypted data from a random group of bits, even though they know everything about the encryption and decryption algorithms.

FIG. 14 is a flow diagram of methods for encrypting data using encryption protocol in accordance with embodiments. The encoder reads the latest counter value 1404 from memory. The encoder checks the logic state of its encoder input lines and assembles these states into the command byte 1402. The command byte, counter, and a static Authentication pattern comprise the data block 1406. Since the Skipjack cipher is a 64-bit data block cipher, this data block is divided into two 64-bit half-blocks, referred to as plaintext A and plaintext B 1408A, 1408B. Each half-block is encrypted using the Skipjack cipher 1410. The two encrypted half-blocks, ciphertext A and ciphertext B 1412A, 1412B, are mixed using an algorithm that is based on the tweakable block cipher CMC 1414, presented below, resulting in two 64-bit half-blocks, ciphertext A′ and ciphertext B′ 1416. The Skipjack cipher is run on ciphertext A′ and ciphertext B′ 1418A, 1418B, resulting in two 64-bit half-blocks, ciphertext A″ and ciphertext B″ 1420A, 1420B. In an embodiment of the method, the encoder checks the Hamming Weight of ciphertext A″ and ciphertext B″ and logically inverts the half-block if its duty cycle is greater than 50% 1422A, 1422B. The user ID is read from memory 1400. The encoder adds a preamble and the user ID to ciphertext A″ and ciphertext B″ 1424A, 1424B to create packet A 1425A and packet B 1425B. Packet A and packet B comprise the message 1426 that is sent to the decoder 1432.

FIG. 15 is a flow diagram of a method of the encryption and transmission protocol 1590, in accordance with an embodiment. The encoder reads the latest counter value and user ID from memory 1500. The counter value is changed to a next value 1502. The encoder checks the logic state of its encoder input lines and assembles these states into the command byte 1504. The command byte, counter, and a static Authentication pattern are assembled into the plaintext 1506. The plaintext is encrypted using an encryption algorithm 1508 to create the ciphertext. A user ID and preamble are added to the ciphertext 1510 to create the packet and the packet is output 1512 for transfer to a decoder. The state of the SEND line is checked 1514. If the SEND line is high, the encoder loops back to change the counter to the next value 1502. If the SEND line is not high, the encoder writes the current counter value to memory 1516 and the method ends 1518.

FIG. 16 is a flow diagram of a method of the encryption and transmission protocol 1690 in accordance with an embodiment. This method provides that the encoder transmits a different encoded packet upon each packet transmission and continues for as long as the SEND line is high 1632. When the SEND line goes low, the latest counter value is written to non-volatile memory 1634 and the algorithm is ended 1636. The encoder reads the counter value and user ID from memory 1600. The counter is decremented 1602. Plaintext A is assembled 1604. Plaintext A is encrypted 1606 to create ciphertext A. The command byte is received 1608 and assembled with plaintext B 1610. Plaintext B is encrypted 1612 to create ciphertext B. ciphertext A and ciphertext B are mixed and split 1614 to create ciphertext A′ and ciphertext B′. ciphertext B′ is encrypted 1616 to create ciphertext B″. A preamble and user ID are added to ciphertext B″ 1620 to create packet B. Packet B is transmitted 1622. ciphertext A′ is encrypted 1624 to create ciphertext B″. A preamble and user ID are added to ciphertext A″ 1628 to create packet A. Packet A is transmitted 1630. The SEND line is checked 1632. The process is repeated at decrementing the counter 1602 for as long as the SEND line is high. When the SEND line goes low, the latest counter value is written to non-volatile memory 1634 and the algorithm is ended 1636.

In another embodiment, an optional test of hamming weight and inversion is performed to ciphertext B″ 1618 and ciphertext A″ 1626.

FIG. 17 is a flow diagram of methods of a decryption protocol 1790, assuming the encryption provided in the embodiment of FIG. 15. A packet is received by the decoder 1700. The decoder checks the preamble of the packet to ensure that it is valid, that is, it matches a predetermined pattern 1702. If the preamble is valid, the decoder removes the preamble and user ID from the packet recovering the ciphertext 1704. A check is made of whether this is the first loop of the receive and decrypt algorithm 1706. If it is the first loop of the receive and decrypt algorithm, the decoder uses the received user ID to find a counter and key in its memory 1708. The decoder uses the key to decrypt the ciphertext 1710 to recover the plaintext. The plaintext is tested for authenticity 1712. This testing includes checking the Authentication pattern and counter for expected values 1714. If the plaintext A is validated, the logical AND function is performed with the command byte and the control permissions to obtain an output byte 1716, which contains the decoder output lines that are to be activated. The AND function compares bits in both bytes and outputs a logic 1 only if the bit is high in both bytes. The result is that if the encoder instructs the decoder to take a line high AND it is allowed by the control permissions, it will be activated.

Latch Mode is checked 1718. If Latch Mode is active, first loop status is checked 1720. If it is the first run through the loop, the activated lines in the output byte are inverted from their current state 1722 and the output lines are set according to the output byte 1724. If Latch Mode is not active, the output lines are set according to the output byte 1724. First loop status is checked 1726, and if this is the first run through the loop, the decoder outputs the user ID on a decoder output line 1728. The decoder sets a timer 1730 and looks for more messages on the DATA input line 1732. If more messages are present, the loop runs again buy receiving a packet B 1700. If there is no data present, the decoder checks to see if the timer has run out 1734. If the timer runs out before more messages arrive, the decoder writes the current counter value to memory 1736 and exits 1740. If any of the validation tests fail 1702, 1714 on the first pass through the loop 1738, the algorithm exits 1740. If any tests fail 1702, 1714 on a subsequent pass through the loop 1738, the timer is reset 1730 and the decoder looks for more messages on the DATA input line 1732.

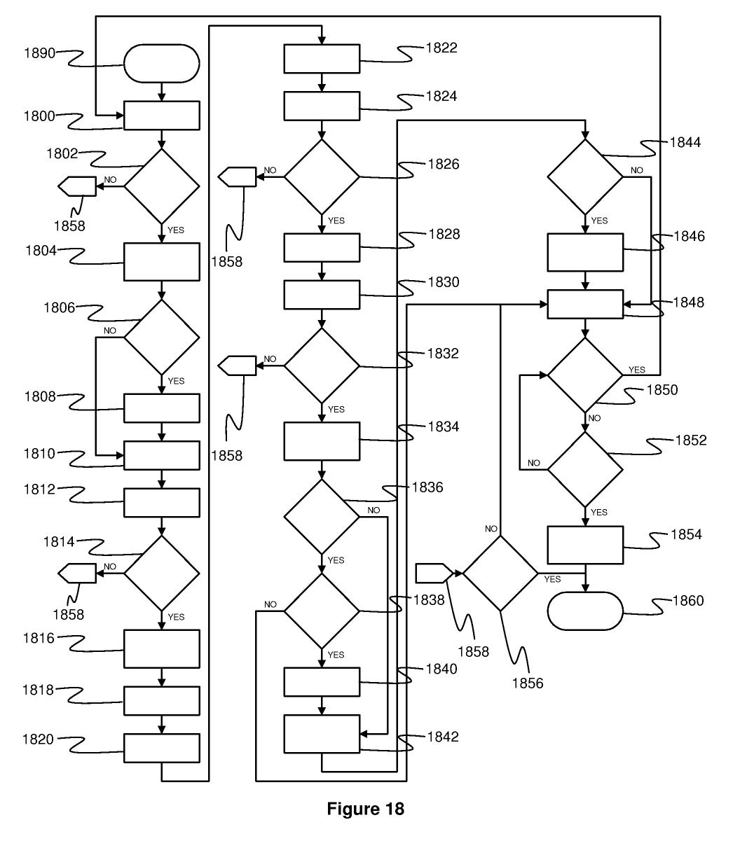

FIG. 18 is a flow diagram of methods of a decryption protocol 1890 in accordance with an embodiment, assuming the encryption provided in the embodiment of FIG. 16. A packet B is received by the decoder 1800. The decoder checks the preamble of packet B to ensure that it is valid, that is, it matches a predetermined pattern 1802. If the preamble is valid, the decoder removes the preamble and user ID from packet B recovering ciphertext B″ 1804. A check is made of whether this is the first loop of the receive and decrypt algorithm 1806. If it is the first loop of the receive and decrypt algorithm, the decoder uses the received user ID to find a counter and key in its memory 1808. The decoder uses the key to decrypt the ciphertext B″ block 1810 to recover the ciphertext B′ block. The decoder receives packet A 1812. The decoder checks the preamble of packet A to ensure that it is valid, that is, it matches a predetermined pattern 1814. If it is validated, the decoder removes the preamble and user ID from packet A recovering the ciphertext A″ block 1816. The decoder uses the key to decrypt ciphertext A″ 1818 to recover the ciphertext A′ block. Ciphertext A′ and ciphertext B′ are run through the inverse of the mixing algorithm to recover ciphertext A and ciphertext B 1820. Ciphertext A is decrypted 1822 and the resulting plaintext A is tested for authenticity 1824. This testing includes checking the Authentication pattern and counter for expected values. If the plaintext A is validated, ciphertext B is decrypted 1828 and the resulting plaintext B is tested for authenticity 1830. This testing includes checking the Authentication pattern and counter for expected values. If the plaintext B is validated, the logical AND function is performed with the command byte and the control permissions to obtain an output byte 1834, which contains the decoder output lines that are to be activated. The AND function compares bits in both bytes and outputs a logic 1 only if the bit is high in both bytes. The result is that if the encoder instructs the decoder to take a line high AND it is allowed by the control permissions, it will be activated.

Latch Mode is checked 1836. If Latch Mode is active, first loop status is checked 1838. If it is the first run through the loop, the activated lines in the output byte are inverted from their current state 1840 and the output lines are set according to the output byte 1842. If Latch Mode is not active, the output lines are set according to the output byte 1842. First loop status is checked 1844, and if this is the first run through the loop, the decoder outputs the user ID on a line 1846. The decoder sets a timer 1848 and looks for more messages on the DATA input line 1850. If more messages are present, the loop runs again buy receiving a packet B 1800. If there is no data present, the decoder checks to see if the timer has run out 1852. If the timer runs out before more messages arrive, the decoder writes the current counter value to memory 1854 and exits 1860. If any of the validation tests fail 1858 on the first pass through the loop 1856, the algorithm exits 1860. If any tests fail 1858 on a subsequent pass through the loop 1856, the timer is reset 1848 and the decoder looks for more messages on the DATA input line 1850.

### Latched or Momentary Outputs

In accordance with an embodiment, the decoder can have either momentary or latched decoder output lines. With momentary decoder output lines, the decoder activates the decoder output lines only for as long as valid messages are received instructing the decoder to activate them. Once the messages stop and the decoder times out, the decoder output lines are deactivated. With latched outputs, the decoder activates the decoder output lines upon reception of a valid message and holds them high until the signal is received a second time, at which point the decoder deactivates them. The decoder must see a break in the messages and times out before it will toggle the state of the decoder output lines.

Referring again to FIG. 18, the decoder checks to see of Latch Mode is activated 1836. If Latch Mode is activated on the decoder, first loop status is checked 1838. If it is the first run through the loop, the latched values are updated in the output byte 1840. In accordance with an embodiment, updating the latched values consists of checking which bits are active in the output byte, and checking the logic state of the associated output lines. The active bits in the output byte are set to the logical inverse of the state of the associated lines. The output lines are set to the logic states set in the output byte 1842. This is accomplished with the logical XOR function.

In accordance with embodiments, this feature can be implemented by having all of the decoder output lines either latched or momentary, based on the state of a single decoder input line. If the decoder input line is high, all of the output lines are latched. If the decoder input line is low, all of the decoder output lines are momentary.

In another embodiment, the decoder can be made more dynamic by allowing the manufacturer or end user to determine which specific decoder output lines are momentary and which ones are latched. The algorithm for this is substantially similar to the algorithm for setting control permissions described in FIG. 7, but instead of determining which decoder output lines are authorized for activation, the decoder output lines that are to be latched or momentary are determined.

Updating the state of the decoder output lines consists of checking the mode of the individual decoder output lines. If the line is momentary, the line is set according to the command in the output byte. If the line is latched, the state of the decoder output line is XORed with the appropriate bit in the command byte, and the decoder output line is set according to the result.

### Encoding System

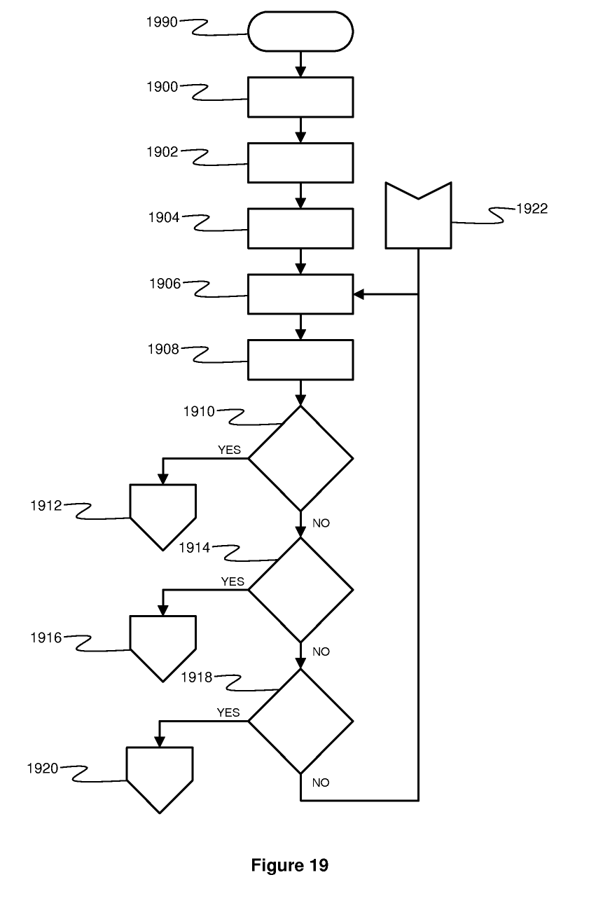

FIG. 19 is a flow diagram of a method of operation of an encoder, in accordance with embodiments. When power is applied to the encoder 1990, the encoder sets up its registers and interrupts 1900, determines the baud rate of the messages from its encoder inputs 1902, deactivates the TX_CNTL line 1904, and goes to sleep 1906. The encoder wakes up when one of its interrupts is triggered 1908. The SEND line is checked 1910. If the SEND line is high, the encoder goes to Test PIN 1912 as provided in the embodiment of FIG. 9, 990. If the SEND line is not high the encoder checks the KEY_IN line 1914. If the KEY_IN line is high, the encoder goes to Get key 1916 as provided in the embodiment of FIG. 6, 690. If the KEY_IN line is not high, the encoder checks the CREATE_PIN line 1918. If the CREATE_PIN line is high, the encoder goes to Create PIN 1920 as provided in the embodiment of FIG. 8, 890. If the CREATE_PIN line is not high, the encoder goes to sleep 1906. As each of these functions end, they return and go to sleep 1922.

### Decoding System

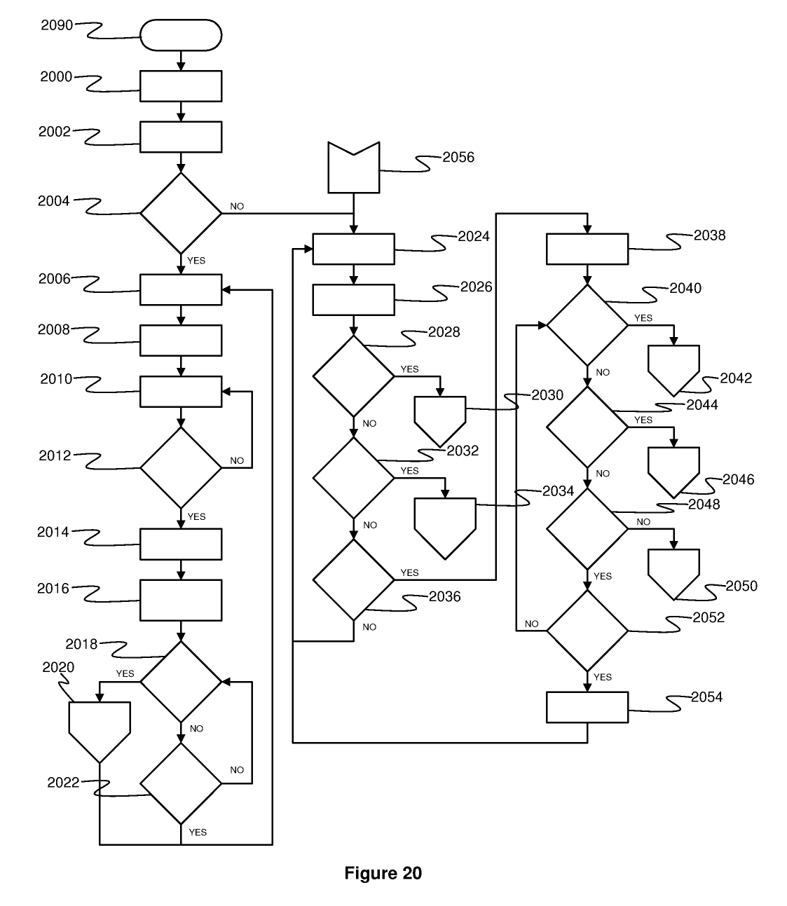

FIG. 20 is a flow diagram of a method of operation of a decoder, in accordance with embodiments. This method is substantially similar to the method described in FIGS. 13 as 1390 and 1300 through 1322 correspond to 2090 and 2000 through 2022, respectively. When power is applied to the decoder 1890, it initializes itself 1800 and determines the baud rate for the messages 1802. The decoder determines if receiver power control has been activated 1804. If not, it goes to sleep 1824. If receiver power control is active, the decoder pulls the RX_CNTL line low to deactivate the receiver 1806. The decoder calculates the “on” and “off” times as described above, and begins a counter for the “off” time 1808. The counter is decremented 1810 and checked to see if it has run out 1812. If the counter has run out, the decoder activates the RX_CNTL line 1814 and starts a timer for the “on” time 1816. The decoder checks to see if data is detected on the decoder input line 1818. If the decoder detects data on a decoder input line, referred to as the DATA_IN line, the decoder goes to a receive and decrypt message 1820. The decoder is active for as long as valid data is being received. The decoder checks to see if the on time has run out 1822. If no data is received by the time the “on” timer runs out, the decoder deactivates the RX_CNTL line 1806, begins the counter for the “off” time 1808, and repeats the loop.

If Receiver Power Control is not active, the decoder goes to sleep 2024. The decoder wakes up when one of its interrupts is triggered 2026. The decoder checks to see if the COPY_IN line is high 2028. If the COPY_IN line is high, the decoder goes to Get Copy 2030 as provided in the embodiment of FIG. 12, 1290. The decoder checks to see if the DATA line is high 2032. If the DATA line is high, the decoder goes to Receive and Decrypt Message 2034 as provided in the embodiment of FIG. 18, 1890. The decoder checks to see if the LEARN line is high 2036. If the LEARN line is high, the decoder sets a timer 2038. The decoder checks to see if the CREATE_KEY line is high 2040. If the CREATE_KEY line is high, the decoder goes to create key 2042, as provided in the embodiment of FIG. 5, 590. The decoder checks to see if the SEND_COPY line is high 2044. If the SEND_COPY line is high, the decoder goes to send copy 2046 as provided in the embodiment of FIG. 11, 1190. The decoder checks to see if the LEARN line goes low 2048. If the LEARN line goes low, the decoder goes to learn mode 2050 as provided in the embodiment of FIG. 7, 790. The decoder checks the status of the timer 2052. If the timer times out, the decoder erases all user data from its memory 2054. As each of the functions end, they return 2056 and go to sleep 2024.

### Wireless Control System

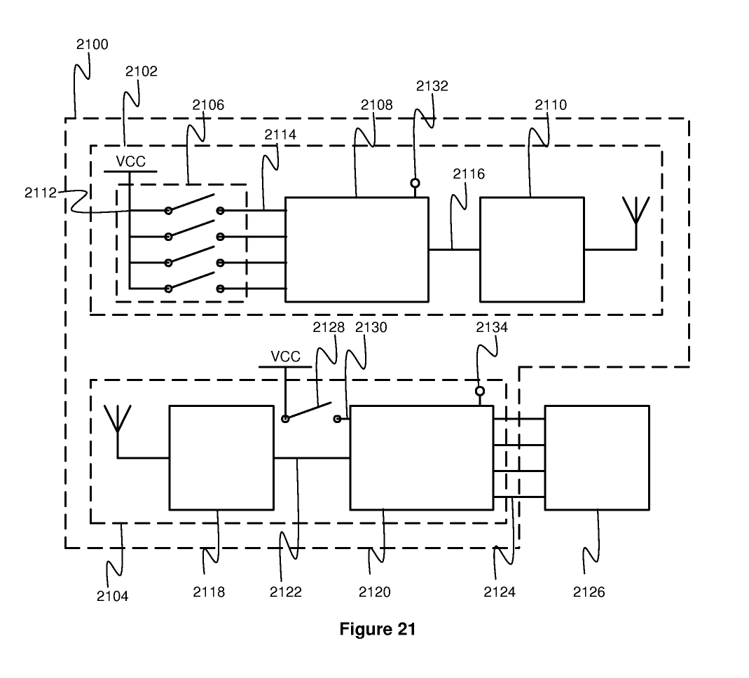

FIG. 21 is a schematic view of an embodiment of a wireless control system 2100, in accordance with an embodiment. The wireless control system 2100 comprises a transmitter product 2102 and a receiver product 2104. The transmitter product 2102 comprises a transmitter switch unit 2106, an encoder 2108, and a transmitter 2110. The transmitter switch unit 2106 comprises one or more transmitter switches 2112, such as, but not limited to, electro-mechanical contacts suitable for providing an open or closed electrical state to the encoder 2108 communicated via an encoder data line 2114. The encoder 2108 comprises an encoder external input line 2132 suitable for communication with a decoder output line 2134 on the decoder 2120. The encoder 2108 further comprises data encrypting means, such as, but not limited to, the 64-bit encryption algorithm in accordance with the embodiment of FIG. 14. When one of the one or more encoder data lines 2114 on the encoder 2108 is activated by a transmitter switch 2112, the encoder 2108 generates an encrypted data packet intended for transmission. The encoder 2108 communicates the data packet to the transmitter 2110 via an encoder output line 2116. The transmitter 2110 is suitable to affect the wireless transmission of the data packet. The data packet can be transmitted by any means of serial data transfer, such as, but not limited to, radio frequency (RF) or infrared (IR).

The wireless control system 2100 further comprises a receiver product 2104. The receiver product 2104 comprises a receiver 2118 and a decoder 2120. The receiver 2118 is suitable for wireless communication with the transmitter 2110, including the reception of the encrypted data packet. The encrypted data packet is communicated from the receiver 2118 to the decoder 2120 via a decoder input line 2122. The decoder 2120 comprises data decrypting means, such as, but not limited to, the 64-bit encryption algorithm in accordance with the embodiment of FIG. 16. The decoder 2120 includes one or more decoder data output lines 2124 that are suitable for communication with the electrical circuitry that is to be controlled 2126. The decoder further comprises a decoder external output line 2124 for communicating with an encoder 2108 via the encoder external input line 2132, by a secure connection, such as, but not limited to, a physical or infrared connection. The decoder also has one or more decoder switch input lines 2130 for connection to a decoder switches 2128 for the purpose of, but not limited to, programming a key. The decoder 2120 is adapted for creating a key by toggling a decoder switch input line 2130 a predetermined number of times between high and low voltage. The decoder 2120 is adapted to communicate the key to the encoder 2108 via a connection between the decoder external output line 2134 and the encoder external input line 2132.

In the preceding description, various aspects of claimed subject matter have been described and specific embodiments have been illustrated and described herein for purposes of description of the preferred embodiment. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the spirit and scope of the claimed subject matter.

1. A method of encryption and decryption for an encoder and decoder wireless transmission system comprising:
reading a latest counter value from memory;
checking the logic state of encoder input lines and assembling these states into a command byte;
generating an n-bit data block comprising the command byte, the counter value, and an authentication value;
encrypting the n-bit data block using a block cipher forming an encrypted data block;
transmitting the encrypted data block to the decoder as a packet;
adjusting the counter value, overwriting the counter value in the memory, and encrypting the n-bit data block upon each packet transmission;
receiving a packet by the decoder;
decrypting the packet using the block cipher; and
setting decoder output lines to the state corresponding to the command byte.

2. The method of claim 1, wherein encrypting the n-bit data block comprises:
dividing the n-bit data block into two m-bit half-blocks referred respectively as plaintext A and plaintext B; and
encrypting plaintext A and plaintext B.

3. (canceled)

4. The method of claim 2, wherein encrypting plaintext A and plaintext B comprises encrypting plaintext A and plaintext B using a block cipher in an encryption mode.

5. (canceled)

6. The method of claim 2, wherein the n-bit data block is a 128-bit data block and encrypting plaintext A and plaintext B comprises:
encrypting plaintext A and plaintext B using a 64-bit block cipher resulting in two 64-bit half-blocks referred respectively as ciphertext A and ciphertext B;
mixing ciphertext A and ciphertext B using a mixing algorithm, resulting in two 64-bit half-blocks referred respectively as ciphertext A′ and ciphertext B′; and
encrypting ciphertext A′ and ciphertext B′ using the 64-bit block cipher resulting in two 64-bit half-blocks referred respectively as ciphertext A″ and ciphertext B″.

7. The method of claim 1, wherein encrypting the n-bit data block comprises encrypting the n-bit data block using a cipher known as the Skipjack cipher.

8. The method of claim 6, wherein encrypting plaintext A and plaintext B comprises encrypting plaintext A and plaintext B using a cipher known as the Skipjack cipher; and wherein encrypting ciphertext A′ and ciphertext B′ comprises encrypting ciphertext A′ and ciphertext B′ using the Skipjack cipher.

9. The method of claim 1, further comprising adding a preamble and a user identification to the encrypted data block prior to transmitting the encrypted data block to the decoder as a packet.

10. The method of claim 8, further comprising adding a preamble and the user identification to ciphertext A″ and ciphertext B″ to create packet A and packet B, respectively, in combination referred to as a message.

11-13. (canceled)

14. The method of claim 10 further comprising:
calculating the hamming weight, defined as the number of ‘1’s in a string of bits, of each of ciphertext A″ and ciphertext B″ to determine the duty cycle before transmission of the respective packet, the duty cycle defined as the ratio of ‘1’s to ‘2’s in the data; and
logically inverting all of the bits in either or both of ciphertext A″ and ciphertext B″ if the respective duty cycle is greater than a threshold.

15. The method of claim 10, wherein decrypting the packet comprises decrypting the message including packet A and packet B, comprising:
receiving the message;
checking the preamble of packet A ensuring that it matches a pre-determined pattern;
removing the preamble and user identification from packet A if the preamble is valid,
checking for inversion due to hamming weight;
recovering ciphertext A″ from packet A;
checking the preamble of packet B ensuring that it matches a pre-determined pattern;
removing the preamble and user identification from packet B if the preamble is valid;
checking for inversion due to hamming weight;
recovering ciphertext B″ from packet B;
using the received user identification to find a counter value and a key in decoder non-volatile memory;
using the key and the decryption algorithm to decrypt ciphertext A″ and ciphertext B″ to recover the plaintext A and plaintext B, respectively; and
testing plaintext A and plaintext B for authenticity by comparing the authentication pattern and counter against expected values stored in non-volatile memory.

16. The method of claim 15, wherein using the key and the decryption algorithm to decrypt ciphertext A″ and ciphertext B″ to recover the plaintext A and plaintext B, respectively, comprises:
using the key and a decryption algorithm corresponding to the encryption algorithm to decrypt the ciphertext A″ block to recover the ciphertext A′ block;
using the key and the decryption algorithm corresponding to the encryption algorithm to decrypt the ciphertext B″ block to recover the ciphertext B′ block;
processing ciphertext A′ and ciphertext B′ with the inverse of the mixing algorithm so as to recover ciphertext A and ciphertext B; and
using the key and the decryption algorithm to decrypt ciphertext A and ciphertext B to recover the plaintext A and plaintext B, respectively.

17. The method of claim 16, further comprising performing the logical AND function on the command byte and control permissions stored in the decoder non-volatile memory to obtain an output byte if the plaintext A and plaintext B are validated, the AND function comparing bits in both bytes and outputting a logic 1 only if the bit is high in both bytes.

18. The method of claim 17 further comprising activating a line on the decoder if the encoder instructs the decoder to take a line high and it is allowed by the control permissions.

19. The method of claim 1 wherein generating an n-bit data block comprising the command byte, the counter value, and an authentication pattern comprises generating a 128-bit data block comprising the command byte, the counter value, and an 80-bit authentication pattern.

20-23. (canceled)

24. The method of claim 17, further comprising:
updating latched values in the output byte on the first loop through the receive and decrypt routine.

25. The method of claim 24, wherein updating the latched values comprises:
checking which bits are active in the output byte;
checking the logic state of the associated output lines;
setting the active bits in the output byte to the logical inverse of the state of the associated lines; and
setting the output lines to the logic states set in the output byte using a logical XOR function.

26-30. (canceled)

31. A system for an encoder and decoder wireless transmission system comprising an encoder and decoder, the encoder comprising:
checker means adapted to check the logic state of encoder input lines and assembling these states into a command byte;
storage means adapted to store the command byte, an authentication value, and a counter value;
combiner means adapted for combining the command byte, the authentication value, and counter value into an n-bit data block;
encryption means adapted to encrypt the n-bit data block forming an encrypted data block;
transmitter means adapted to transmit the encrypted data block as a packet to the decoder; and
decrementer means adapted for decrementing the counter and encrypting the data block upon each packet transmission;
the decoder comprising:
storage means adapted to store a key and the counter value;
receiver means adapted to receive the encrypted data block as a packet from the encoder;
reader means adapted to read the key and the counter value;
decryption means adapted to decrypt the data block using the key and the block cipher to recover the command byte; and
setter means adapted to set the decoder output lines to the state corresponding to the command byte.

32. The system of claim 31, wherein the combiner means adapted to combine the command byte, authentication value, and counter value into a data block and the encryption means adapted to encrypt the data block comprises:
combiner means adapted for combining the command byte, the authentication value, and counter value into an n-bit data block;
divider means adapted for dividing the n-bit data block into two m-bit half-blocks plaintext A and plaintext B, respectively;
encryption means adapted for encrypting each of the plaintext A and plaintext B generating ciphertext A″ and ciphertext B″;
adder means adapted for adding a user identification value and a preamble value to each of the ciphertext A″ and ciphertext B″ generating packet A and packet B, respectively; and
transmitter means adapted to transmit packet A and packet B as a message to the decoder;
and wherein the receiver means adapted for receiving the packet from the encoder, reader means adapted for reading the key and the counter value, and decryption means adapted for decrypting the encoder data block using the key and recovering the command byte comprises:
receiver means adapted for receiving the message including packet A and packet B from the encoder;
remover means adapted for removing the preamble and identification value from each of packet A and packet B recovering ciphertext A″ and ciphertext B″, respectively;
reader means adapted for reading the key and the counter value; and
decryption means adapted for decrypting ciphertext A″ and ciphertext B″ using the key and the block cipher recovering plaintext A and plaintext B, respectively.

33. The system of claim 32, wherein the encryption means adapted for encrypting the plaintext A and plaintext B generating ciphertext A″ and ciphertext B″ comprises:
encryption means adapted for encrypting each of the plaintext A and plaintext B generating ciphertext A and ciphertext B, respectively;
mixer means adapted for mixing ciphertext A and ciphertext B and means for dividing into ciphertext A′ and ciphertext B′;
encryption means adapted for encrypting each of the ciphertext A′ and ciphertext B′ generating ciphertext A″ and ciphertext B″; and
adder means adapted for adding a user identification value and a preamble value to each of the ciphertext A″ and ciphertext B″ generating packet A and packet B, respectively;
and wherein decryption means adapted for decrypting ciphertext A″ and ciphertext B″ using the key and recovering plaintext A and plaintext B, respectively, comprises:
decryption means adapted for decrypting ciphertext A″ and ciphertext B″ using the key and the block cipher recovering ciphertext A′ and ciphertext B′, respectively;
unmixer means adapted for unmixing ciphertext A′ and ciphertext B′ recovering ciphertext A and ciphertext B, respectively; and
decryption means adapted for decrypting ciphertext A and ciphertext B using the block cipher recovering plaintext A and plaintext B, respectively.

34. The system of claim 31, further comprising:
a decoder input line in electrical communication with the decoder;
voltage means adapted for supplying a voltage;
a switch in electrical communication between the decoder input line and the voltage means adapted for supplying a voltage, the switch adapted to supply voltage to the decoder input line upon the closing of the switch; and
a timer in electrical communication with the decoder input line, the timer adapted to sense the state of the input line and output a multi-bit timer value upon sensing a voltage or not sensing a voltage; wherein storage means adapted for storing a key in the decoder comprises decoder non-volatile memory in communication with the timer, the decoder non-volatile memory adapted to store one or more bits of each multi-bit timer value and combine them with any previously stored bits of multi-bit timer values, defining a key.

35. The system of claim 34, wherein storage means adapted for storing a key in the encoder comprises encoder non-volatile memory, the encoder further comprising encoder communication means for communicating with the decoder non-volatile memory,
the decoder further comprising decoder communication means adapted for communicating with the encoder non-volatile memory, the decoder adapted to communicate the contents of the decoder non-volatile memory to the encoder non-volatile memory via the encoder communication means adapted for communicating with the decoder non-volatile memory and the decoder communication means adapted for communicating with the encoder non-volatile memory.

36-37. (canceled)

38. A wireless transmission system comprising a transmitter product and a receiver product, the transmitter product comprising:
a transmitter switch unit;
an encoder; and
a transmitter, the transmitter switch unit comprises one or more transmitter switches suitable for providing an open or closed electrical state to the encoder communicated via an encoder data line, the encoder comprises an encoder input line suitable for communication with a decoder output line on the decoder, the encoder further comprises a counter and an encryption means adapted for encrypting a data block using a counter value and an encryption algorithm into an encrypted data block as a packet, the transmitter adapted to transmit the packet to the receiver product, the encoder adapted to communicate the packet to the transmitter, the transmitter adapted to affect a wireless transmission of the packet, the encoder adapted to decrement the counter and encrypt the data block upon each packet transmission,
the receiver product comprises a receiver and a decoder, the receiver is adapted to receive the data packet via wireless communication with the transmitter, the receiver being in electrical communication with the decoder via a decoder input line, the decoder further comprises a decryption means for decrypting the encoded data block in the packet using an encryption algorithm, the decoder includes one or more decoder output lines adapted for communication with electrical circuitry, the decoder further includes decoder output lines for communicating with the encoder, the decoder includes one or more decoder input lines adapted for electrical communication with decoder switches, the decoder comprising means for creating a key.

39. The wireless transmission system of claim 38, wherein the encryption means for encrypting comprises encryption means for encrypting using an encryption algorithm operated in a mode of operation.

40. (canceled)

41. The wireless transmission system of claim 38, wherein the means for encrypting the n-bit data block forming an encrypted data block comprises:
divider means for dividing the n-bit data block into two m-bit half-blocks plaintext A and plaintext B, respectively;
encryption means for encrypting each of the plaintext A and plaintext B generating ciphertext A and ciphertext B, respectively;
mixer means for mixing ciphertext A and ciphertext B and divider means for dividing into ciphertext A′ and ciphertext B′;
encryption means for encrypting each of the ciphertext A′ and ciphertext B′ generating ciphertext A″ and ciphertext B″;
adder means for adding a user identification value and a preamble value to each of the ciphertext A″ and ciphertext B″ generating packet A and packet B, respectively; and
wherein decryption means for decrypting ciphertext A″ and ciphertext B″ and recovering plaintext A and plaintext B, respectively, comprises:
decryption means for decrypting ciphertext A″ and ciphertext B″ recovering ciphertext A′ and ciphertext B′, respectively;
unmixer means for unmixing ciphertext A′ and ciphertext B′ recovering ciphertext A and ciphertext B, respectively; and
decryption means for decrypting ciphertext A and ciphertext B recovering plaintext A and plaintext B, respectively.

42. The wireless transmission system of claim 38, the decoder further comprising:
an input line;
voltage means for supplying a voltage;
a switch in electrical communication between the input line and the voltage means, the switch adapted to supply voltage to the input line upon the closing of the switch; and
a timer in electrical communication with the input line, the timer adapted to sense the state of the input line and output a multi-bit timer value upon sensing a voltage or not sensing a voltage,
wherein storage means for storing a key in the decoder comprises decoder non-volatile memory in communication with the timer, the decoder non-volatile memory adapted to store one or more bits of each multi-bit timer value and combine them with any previously stored bits of multi-bit timer values defining a key.

43. The wireless transmission system of claim 42, wherein storage means for storing a key in the encoder comprises encoder non-volatile memory, the encoder further comprising encoder communicator means for communicating with the decoder non-volatile memory;
the decoder further comprising decoder communicator means for communicating with the encoder non-volatile memory, the decoder adapted to communicate the contents of the decoder non-volatile memory to the encoder non-volatile memory via the decoder communicator means for communicating with the decoder non-volatile memory and the encoder communicator means for communicating with the encoder non-volatile memory.

44-98. (canceled)

99. A decoder microchip comprising:
means for checking the logic state of encoder input lines and assembling these states into a command byte;
means for storing the command byte, an authentication value, and a counter value;
means for combining the command byte, the authentication value, and counter value into an n-bit data block;
means for encrypting the n-bit data block forming an encrypted data block; and
means for decrementing the counter and encrypting the data block upon each packet transmission.

100-119. (canceled)
